(19) United States
(12) Patent Application Publication
(10) Pub. No.: US 2026/0231020 A1
(43) Pub. Date: Aug. 6, 2026

(54) PHASE TRACKING REFERENCE SIGNAL AND DATA POWER BOOSTING FOR UPLINK MUTING IN SUBBAND FULL-DUPLEX

(71) Applicant: QUALCOMM Incorporated, San Diego, CA (US)

(72) Inventors: Abdelrahman Mohamed IBRAHIM, San Diego, CA (US); Muhammad Sayed Khairy ABDELGHAFFAR, San Jose, CA (US); Qian ZHANG, Basking Ridge, NJ (US)

(21) Appl. No.: 19/046,448

(22) Filed: Feb. 5, 2025

(51) Int. Cl. H04W 52/02; H04L 5/00

(52) U.S. Cl. CPC H04W 52/0216; H04L 5/0051; H04L 5/0053

(57) ABSTRACT

Certain aspects of the present disclosure provide techniques for wireless communications. An example method includes obtaining a first configuration that schedules transmission of a phase tracking reference signal (PT-RS) on one or more first resource elements of a first symbol; obtaining a second configuration comprising a muting pattern for the first symbol, the muting pattern indicating one or more second resource elements to be muted on the first symbol; and sending, according to a power boosting scheme associated with the PT-RS and the muting pattern, an uplink message on the first symbol in accordance with the PT-RS and the muting pattern.

### FIELD OF THE DISCLOSURE

Aspects of the present disclosure relate to wireless communications, and more particularly, to techniques for applying power boosting to resource elements (REs) in uplink (UL) messages.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining a first configuration that schedules transmission of a phase tracking reference signal (PT-RS) on one or more first resource elements of a first symbol; obtaining a second configuration comprising a muting pattern for the first symbol, the muting pattern indicating one or more second resource elements to be muted on the first symbol; and sending, according to a power boosting scheme associated with the PT-RS and the muting pattern, an uplink message on the first symbol in accordance with the PT-RS and the muting pattern.

Certain aspects provide a method for wireless communications by a network entity. The method includes sending a first configuration that schedules transmission of a PT-RS on one or more first resource elements of a first symbol; sending a second configuration comprising a muting pattern for the first symbol, the muting pattern indicating one or more second resource elements to be muted on the first symbol; and obtaining, according to a power boosting scheme associated with transmission of the PT-RS and the muting pattern, an uplink message on the first symbol in accordance with the PT-RS and the muting pattern.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIGS. 5A, 5B, and 5C depict example configurations for full-duplex communications.

FIGS. 6A, 6B, and 6C depict examples of interference scenarios based on full-duplex communications.

FIG. 7 depicts examples of phase tracking reference signal (PT-RS) configurations.

FIG. 8 depicts an example wireless communications network.

FIG. 9 depicts an example PT-RS configuration with muted resource elements (REs).

FIG. 10 depicts a process flow for communications in a network between a network entity and a UE.

FIG. 11 depicts a method for wireless communications.

FIG. 12 depicts another method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for applying a power boosting to phase tracking reference signal (PT-RS) resource elements (REs) and/or data REs in an uplink (UL) message when one or more REs are muted in the UL message.

A wireless communication network may include a number of devices and network entities employing techniques for exchanging information wirelessly. For example, a wireless communication network may include devices (e.g., user equipments (UEs)) and network entities (e.g., base stations (BSs), NodeBs, enhanced NodeBs (eNBs), next generation NodeBs (gNBs or gNodeBs), etc.) that wirelessly communicate data, control information, reference signals, etc. (e.g., according to various wireless communication network implementations). The wireless communication network may employ various technologies to improve throughput, achieve a high data rate, and/or improve the energy efficiency of the wireless communication network. These technologies may allow a wireless communication network to support communication between an increasing number of devices and network entities, support advanced functionalities at various devices, and improve the quality of communication between devices and network entities.

Network entities and/or devices in a wireless communications network may experience different types of interference to their communications. As described herein, one of the types of interference that affect the communications may include cross-link interference (CLI). For example, CLI may include first communications for a first device or first network entity experiencing interference from second communications for a second device or second network entity, where the first communications and the second communications may occur at a same time (e.g., on same time-domain resources, such as a same slot). That is, UL communications transmitted by the first device or first network entity may cause CLI on downlink (DL) communications for the second device or second network entity. Additionally or alternatively, DL communications for the first device or first network entity may cause CLI on UL communications for the second device or second network entity

In some aspects, the CLI may arise due to full-duplex communications. For example, a first network entity associated with a first cell (e.g., first coverage area) may employ full-duplex communications for simultaneous transmission of DL communications and reception of UL communications with devices in the first cell on same time-domain resources. In the case of CLI, a second network entity associated with a second cell (e.g., second coverage area) may also employ full-duplex communications for simultaneous transmission of DL communications and reception of UL communications with devices in the second cell on at least a portion of the same time-domain resources as the first network entity, where the first cell and the second cell neighbor each other (e.g., the first network entity and the second network entity at least partially overlap and/or are in close proximity to each other). Accordingly, UL communications sent to the first network entity may cause CLI to DL communications sent by the second network entity, and/or UL communications sent to the second network entity may cause CLI to DL communications sent by the first network entity. In some aspects, the CLI caused by communications between different network entities may be referred to as inter-network entity CLI (e.g., inter-gNB CLI). Additionally or alternatively, the inter-network entity CLI may include DL communications sent by one of the network entities causing CLI on UL communications sent to another network entity. In some aspects, CLI may also include intra-cell inter-UE CLI (e.g., CLI from communication between a first UE and a network entity interfering with a communication between a second UE and the network entity in a same cell) and/or inter-cell inter-UE CLI (e.g., CLI from communication between a first UE and a first network entity interfering with a communication between a second UE and a second network entity, where the UEs are associated with different cells corresponding to the respective network entities).

As described herein, one technique to mitigate the inter-network entity CLI may include a network entity indicating for a UE to apply UL resource muting (e.g., muting one or more UL resources, such as UL REs) according to a muting pattern when the UE sends an UL message to the network entity (e.g., sent on a physical uplink shared channel (PUSCH)). To mute an UL resource, the UE may refrain from sending data, signaling, and/or information in the UL resource. For example, the UE may perform a transmission with zero power or reduced power at the UL resource. The network entity may then use the muted resource to measure and/or estimate transmission non-idealities, such as interference (e.g., the inter-network entity CLI) or noise, from other signals that impact the UL message.

Subsequently, the network entity may use the measured and/or estimated transmission non-idealities on the muted resources to adjust one or more transmission parameters to mitigate effects on communications that arise from the transmission non-idealities. For example, the network entity may perform corrections or adjustments on subsequent DL messages sent to the UE to mitigate the measured and/or estimated transmission non-idealities. Additionally or alternatively, the network entity may indicate corrections or adjustments for the UE to apply to subsequent UL messages sent to the network entity to mitigate the measured and/or estimated transmission non-idealities. In some aspects, the corrections or adjustments may include using a higher or lower transmission power, adjusting a modulation and coding scheme (MCS), adjusting resource allocations, etc., for sending the DL or UL messages. In some aspects, when UL resource muting is employed in an UL message as part of mitigation for the inter-network entity CLI, a power boosting may be assumed for REs that are not muted in the UL message (e.g., REs that carry data and/or other signaling, which may be referred to as data REs) to maintain a transmit power of the UL message across a plurality of symbols that include symbols with muted REs and symbols with REs that are not muted.

In some aspects, a network entity may indicate for a UE to send a PT-RS and to apply UL resource muting on one or more same symbols of an UL message. For example, the network entity may indicate for the UE to send a PT-RS on one or more REs of an UL message according to a PT-RS configuration, where the one or more REs are located in same symbol(s) as REs that are indicated to be muted. The PT-RS is designed to enable the network entity to track the phase of a received signal (e.g., the UL message) from the UE to mitigate the effects of phase noise for signals or messages sent by the UE, where the phase noise may be referred to as a common phase error (CPE) (e.g., appearing as a common phase rotation of subcarriers in the received signal). Accordingly, the PT-RS may enable the network entity to track a phase of a local oscillator at the transmitter of the UE and at a receiver of the network entity and may enable suppression of phase noise and CPE by the network entity. That is, the PT-RS may enable the network entity to estimate CPE of UL message(s) from a UE to then mitigate the CPE for subsequent UL message(s) by indicating for the UE to adjust one or more parameters for the subsequent UL messages. As part of the PT-RS configuration, the network entity may indicate whether the UE is to apply a power boosting (e.g., increasing a transmission power) to the REs carrying the PT-RS.

One or more technical problems may arise when a UE is configured to send an UL message (e.g., a message sent via a PUSCH) that includes both a PT-RS and UL resource muting on at least one same symbol of the UL message, where the PT-RS and muted resources (e.g., according to the UL resource muting) are located on different tones or subcarriers of the same symbol. For example, without PT-RS, the UE may send the UL message with maintaining a PUSCH transmit power across all symbols of the UL message. In some aspects, the UE may attempt to maintain the PUSCH transmit power across all symbols based on applying a power boost to REs that are not muted (e.g., data REs) in corresponding symbol(s) as described previously. However, this power boost may be based on an assumption that half of the REs in symbols that include UL resource muting are allocated to data REs (e.g., without PT-RS). As such, if the UE is configured to send the PT-RS and apply the UL resource muting in a same symbol of the UL message, less than half of the REs in such symbol(s) may be allocated to data REs because the PT-RS may be sent on one or more REs originally allocated to the data REs. Accordingly, even with the power boost, the PUSCH transmit power may differ between symbols with the UL resource muting and symbols without the UL resource muting.

The techniques and apparatuses described herein provide a technical solution for maintaining a PUSCH transmit power or reducing a difference of PUSCH transmit powers between symbols with the UL resource muting and symbols without the UL resource muting for an UL message that is configured to carry a PT-RS and resource-muted symbols. For example, a UE may send an UL message that includes PT-RS and UL resource muting according to a power boosting scheme associated with the PT-RS and the muting pattern. The power boosting scheme may maintain a PUSCH transmit power or may reduce a difference of PUSCH transmit powers between symbols with the UL resource muting and symbols without the UL resource muting.

In some aspects, the power boosting scheme may indicate a same power boosting value for RE(s) that carry the PT-RS and for data REs (e.g., REs that are not muted according to the UL resource muting and/or do not carry the PT-RS). Additionally or alternatively, the power boosting scheme may indicate a first power boosting value for the data REs and a second power boosting value for the RE(s) that carry the PT-RS. Additionally or alternatively, the power boosting scheme may indicate a power boosting factor for the data REs (e.g., based on a PT-RS density) and may indicate not to apply a power boosting to the RE(s) that carry the PT-RS. Additionally or alternatively, the power boosting scheme may indicate a power boosting value for the data REs and a power boosting factor for the RE(s) that carry the PT-RS, where the power boosting factor is associated with a same per-symbol power across all symbols of the UL message.

In certain aspects, certain techniques for using a power boosting scheme for an UL message that is configured with UL resource muting and configured to carry a PT-RS as described herein may provide any of various beneficial effects and/or advantages. For example, the power boosting scheme may enable the UE to maintain a PUSCH transmit power or to reduce a difference of PUSCH transmit powers between symbols with the UL resource muting and symbols without the UL resource muting for the UL message that is also configured to carry the PT-RS. By maintaining the PUSCH transmit power or reducing a difference of PUSCH transmit powers between symbols with the UL resource muting and symbols without the UL resource muting for the UL message that is also configured to carry the PT-RS, the UE may increase a reliability that the UL message is successfully received and decoded by a network entity, thereby increasing communication reliability.

In some aspects, the different options for the power boosting scheme described above may enable the UE to maintain the PUSCH transmit power or to reduce the difference of PUSCH transmit powers between symbols with the UL resource muting and symbols without the UL resource muting for the UL message that is also configured to carry the PT-RS. For example, the same power boosting value for RE(s) that carry the PT-RS and for the data REs may reduce the difference of PUSCH transmit powers between symbols and may include less computational complexity at the UE. Additionally or alternatively, the first power boosting value for the data REs and the second power boosting value for the RE(s) that carry the PT-RS may also reduce the difference of PUSCH transmit powers between symbols and include less complexity at the UE. Additionally or alternatively, the power boosting factor for the data REs and not applying the power boosting to the RE(s) that carry the PT-RS may maintain the PUSCH transmit power between symbols. Additionally or alternatively, the power boosting value for the data REs and the power boosting factor for the RE(s) that carry the PT-RS may also maintain the PUSCH transmit power between symbols.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

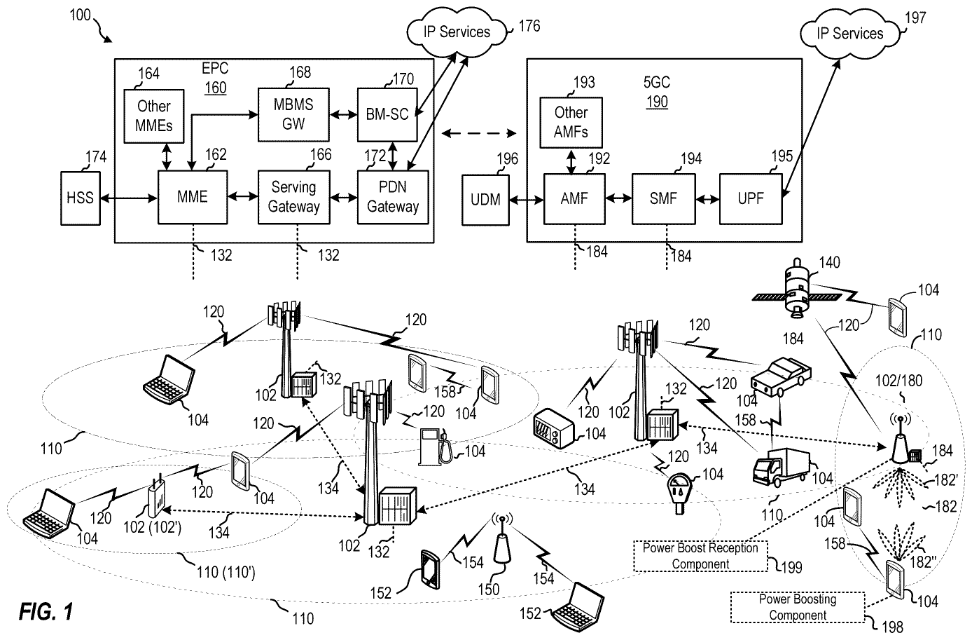

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include UL (also referred to as reverse link) transmissions from a UE 104 to a BS 102 and/or DL (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

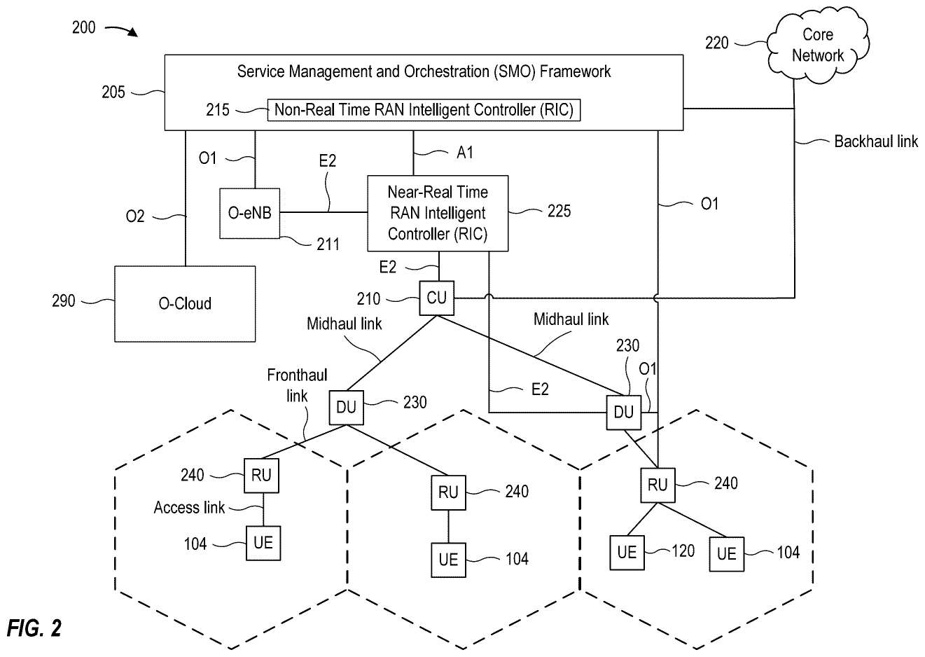

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G New Radio (NR) or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 megahertz (MHz)-7125 MHz, which is often referred to (interchangeably) as “Sub-6 gigahertz (GHz)”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., BS 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

UE 104 includes a power boosting component 198, which may be used to apply a power boosting to PT-RS REs and/or data REs in an UL message when one or more REs are muted in the UL message as further described herein. Further, a BS 102 includes a power boost reception component 199, which may be used to obtain (e.g., receive) an UL message that includes data REs, PT-RS RE(s), and muted RE(s), where the data REs and/or the PT-RS RE(s) may be power boosted as further described herein.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

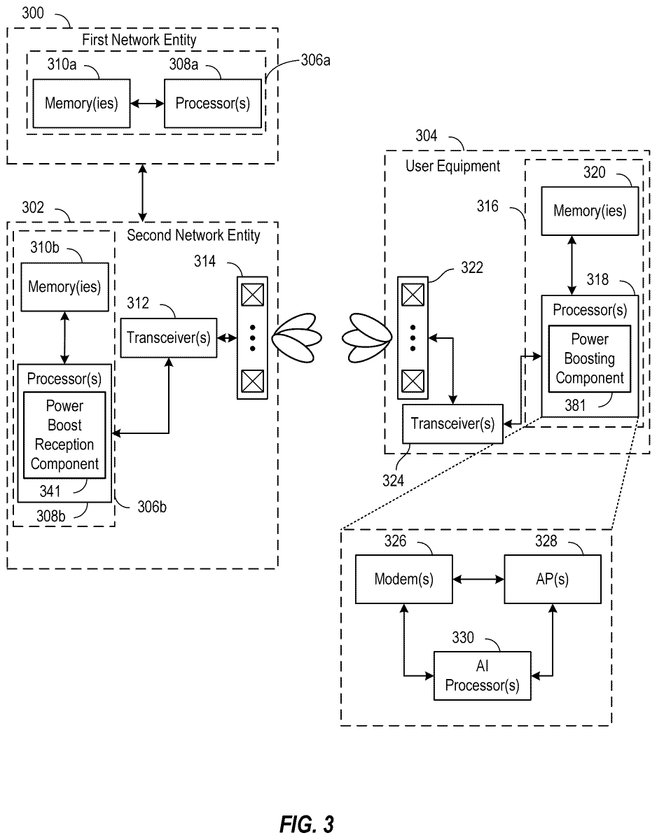

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example DL transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a transmitter (TX) MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a DL signal. Second network entity 302 may transmit the DL signal via the one or more antennas 314.

In order to receive the DL transmission at UE 304 (or a sidelink transmission from another UE), the one or more antennas 322 may receive the DL signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, a receiver (RX) MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example UL transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for single-carrier frequency division multiplexing (SC-FDM)), and transmitted to second network entity 302.

At second network entity 302, the UL signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

In the depicted example, the processor(s) 308b includes a power boost reception component 341, which may be representative of the power boost reception component 199 of FIG. 1. Notably, while depicted as an aspect of processor(s) 308b, the power boost reception component 341 may be implemented additionally or alternatively in various other aspects of a network entity (e.g., a BS 102) in other implementations. Further, the processor(s) 318 includes a power boosting component 381, which may be representative of the power boosting component 198 of FIG. 1. Notably, while depicted as an aspect of the processor(s) 318, the power boosting component 381 may be implemented additionally or alternatively in various other aspects of a UE 104 in other implementations.

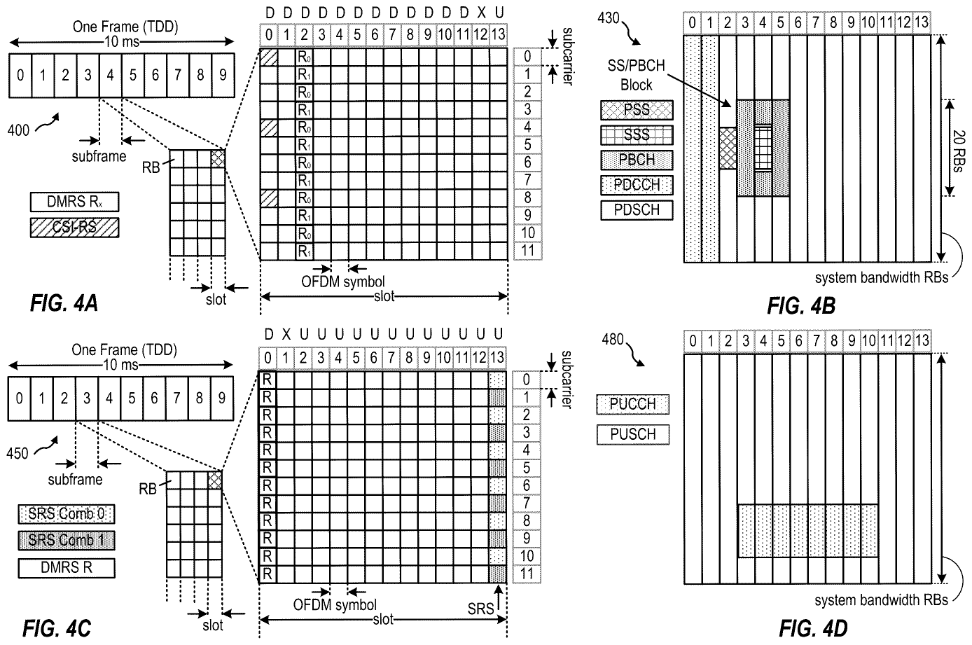

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the UL and DL. Such systems may also support half-duplex operation using time division duplexing (TDD). OFDM and SC-FDM partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 24 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 24× 15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ acknowledgement (ACK)/negative acknowledgement (NACK) feedback. The PUSCH carries data, and may additionally be used to carry a buffer status report (BSR), a power headroom report (PHR), and/or UCI.

### Aspects Related to Full-Duplex Communications and CLI

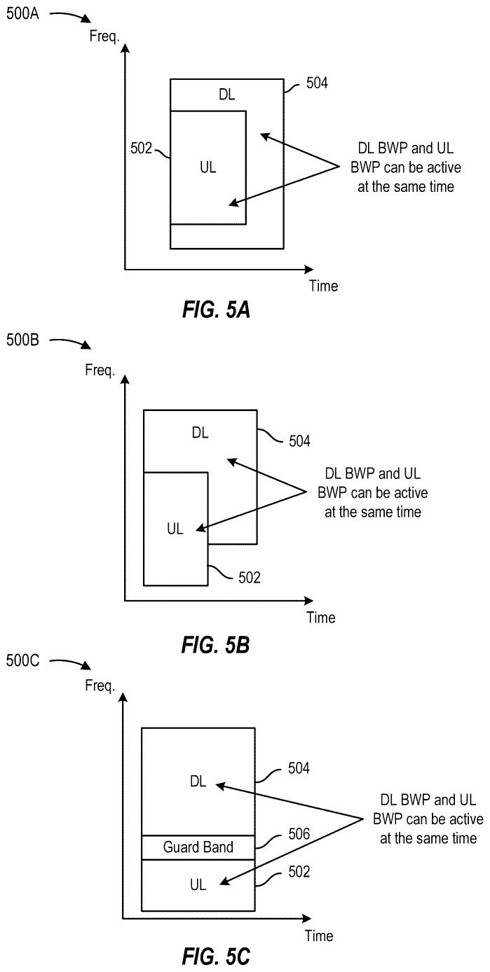

FIGS. 5A, 5B, and 5C depict example configurations for full-duplex communications in accordance with aspects of the present disclosure. For example, FIG. 5A depicts a first configuration 500A for full-duplex communications, FIG. 5B depicts a second configuration 500B for full-duplex communications, and FIG. 5C depicts a third configuration 500C for full-duplex communications. In some aspects, the first configuration 500A, the second configuration 500B, and the third configuration 500C may implement aspects of or may be implemented by aspects of FIGS. 1-4D. For example, a network entity or a UE may use the first configuration 500A, the second configuration 500B, or the third configuration 500C for full-duplex communications. In some aspects, the network entity may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE may be an example of the UE 104 depicted and described with respect to FIG. 1 or the UE 304 depicted and described with respect to FIG. 3. Additionally, the first configuration 500A, the second configuration 500B, and the third configuration 500C may include aspects of the data structures for a wireless communications network depicted and described with respect to FIGS. 4A-4D.

As used herein, full-duplex communications in a wireless network refers to simultaneous bi-directional communication between devices in the wireless network. For example, a UE operating in a full-duplex mode may transmit an UL communication in an UL resource allocation 502 (e.g., an UL bandwidth part (BWP)) and receive a DL communication in a DL resource allocation 504 (e.g., a DL BWP) at the same time (e.g., in the same slot or the same symbol), and/or a network entity operating in a full-duplex mode may receive an UL communication in the UL resource allocation 502 and transmit a DL communication in the DL resource allocation 504 at the same time. Alternatively, half-duplex communications in a wireless network refers to unidirectional communications (e.g., only DL communication or only UL communication) between devices at a given time (e.g., in a given slot or a given symbol).

As shown in FIGS. 5A and 5B, the first configuration 500A and the second configuration 500B show examples of in-band full-duplex (IBFD) communication. In IBFD, the UE may transmit an UL communication to a network entity in the UL resource allocation 502 and receive a DL communication from the network entity in the DL resource allocation 504 on one or more same time and frequency resources, or the network entity may transmit a DL communication to a UE in the DL resource allocation 504 and receive an UL communication from the UE in the UL resource allocation 502 on one or more same time and frequency resources. As shown in the first configuration 500A, in a first example of IBFD, time and frequency resources for the UL resource allocation 502 may fully overlap with time and frequency resources for the DL resource allocation 504. As shown in the second configuration 500B, in a second example of IBFD, time and frequency resources for the UL resource allocation 502 may partially overlap with time and frequency resources for the DL resource allocation 504.

As further shown in FIG. 5C, the third configuration 500C shows an example of subband full-duplex (SBFD) communications, which may also be referred to as “subband frequency division duplex (SBFDD)” or “flexible duplex.” In SBFD, the UE may transmit an UL communication to a network entity in the UL resource allocation 502 and receive a DL communication from the network entity in the DL resource allocation 504 at the same time, but on different frequency resources. Additionally or alternatively, in SBFD, the network entity may transmit a DL communication to a UE in the DL resource allocation 504 and receive an UL communication from the UE in the UL resource allocation 502 at the same time, but on different frequency resources. For example, the different frequency resources may be subbands of a frequency band, such as a TDD band. In this case, the frequency resources used for the DL resource allocation 504 may be separated from the frequency resources used for the UL resource allocation 502, in the frequency domain, by a guard band 506.

SBFD may increase an UL duty cycle, improve UL coverage, and reduce latency, because it is possible to transmit an UL signal in an UL subband in DL only or in flexible slots. SBFD may enhance system capacity, resource utilization, and spectrum efficiency. SBFD may enable flexible and dynamic UL and DL resource adaption according to UL and DL traffic in a robust manner. If random access is allowed in SBFD symbols for SBFD-aware UEs (UEs capable of supporting SBFD operation), it may potentially reduce the random access latency, reduce the PRACH collision probability, and/or improve the coverage of PRACH and messages for a RACH procedure. A random access channel (RACH) configuration may indicate a quantity of synchronization signal blocks (SSBs) per RACH occasion (RO) and power information for PRACH messages (e.g., preambles).

As indicated above, FIGS. 5A, 5B, and 5C are provided as examples. Other examples may differ from what is described with respect to FIGS. 5A, 5B, and 5C.

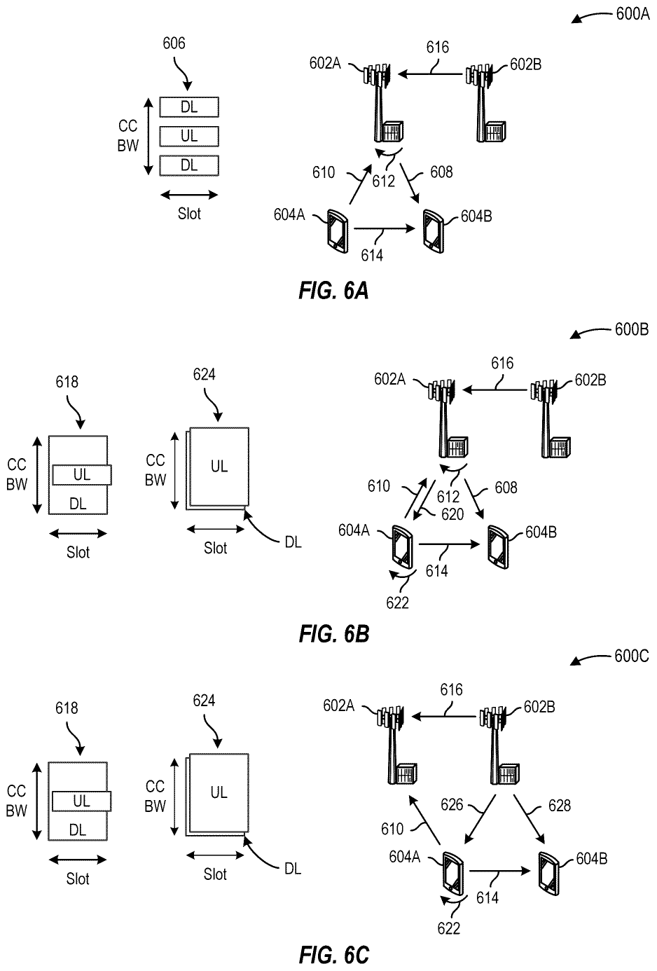

FIGS. 6A, 6B, and 6C depict examples of interference scenarios based on full-duplex communications. For example, FIG. 6A depicts a first interference scenario 600A based on full-duplex communications, FIG. 6B depicts a second interference scenario 600B based on full-duplex communications, and FIG. 6C depicts a third interference scenario 600C based on full-duplex communications.

In some aspects, the first interference scenario 600A, the second interference scenario 600B, and the third interference scenario 600C may implement aspects of or may be implemented by aspects of FIGS. 1-5C. For example, the first interference scenario 600A, the second interference scenario 600B, and the third interference scenario 600C may include a first network entity 602A, a second network entity 602B, a first UE 604A, and a second UE 604B. In some aspects, the first network entity 602A and the second network entity 602B may be examples of the BS 102 depicted and described with respect to FIG. 1, the first network entity 300 or the second network entity 302 depicted and described with respect to FIG. 3, a disaggregated base station depicted and described with respect to FIG. 2, or the network entity described with respect to FIGS. 5A-5C. Similarly, the first UE 604A and the second UE 604B may be examples of the UE 104 depicted and described with respect to FIG. 1, the UE 304 depicted and described with respect to FIG. 3, or the UE described with respect to FIGS. 5A-5C. Additionally, the first interference scenario 600A, the second interference scenario 600B, and the third interference scenario 600C may include aspects of the data structures for a wireless communications network depicted and described with respect to FIGS. 4A-4D. FIGS. 6A, 6B, and 6C are provided as examples. Other examples of interference scenarios may differ from what is described with respect to FIGS. 6A, 6B, and 6C.

In the first interference scenario 600A depicted in the example of FIG. 6A, the first network entity 602A (e.g., a full-duplex gNB) may use a SBFD communication 606 (e.g., the SBFD communications depicted and described with respect to FIG. 5C) to concurrently communicate with the first UE 604A (e.g., a half-duplex UE) and the second UE 604B (e.g., a half-duplex UE). For example, the first network entity 602A may send a DL transmission 608 to the second UE 604B at the same time that the first UE 604A sends an UL transmission 610 to the first network entity 602A. In the first interference scenario 600A, the DL transmission 608 may result in a network entity self-interference 612 at the first network entity 602A when the first network entity 602A is attempting to decode the UL transmission 610. In some aspects, the UL transmission 610 may result in a inter-UE CLI 614 (e.g., an intra-cell UE-to-UE CLI) at the second UE 604B when the second UE 604B is attempting to decode the DL transmission 608.

Additionally, in the first interference scenario 600A depicted in the example of FIG. 6A, the second network entity 602B (e.g., a full-duplex gNB) may transmit a DL transmission to an additional UE (not shown) at the same time that the first UE 604A transmits the UL transmission 610 to the first network entity 602A. Accordingly, the DL transmission by the second network entity 602B may result in an inter-network entity CLI 616 (e.g., inter-gNB CLI) at the first network entity 602A when the first network entity 602A is attempting to decode the UL transmission 610.

In the second interference scenario 600B depicted in the example of FIG. 6B, the first network entity 602A (e.g., a full-duplex gNB) may concurrently use a full-duplex communication 618 (e.g., the partially-overlapping IBFD communications depicted and described with respect to FIG. 5A) or a full-duplex configuration 624 (e.g., the full-overlapping IBFD communications depicted and described with respect to FIG. 5B) to communicate with the first UE 604A (e.g., a full-duplex UE) and half-duplex communication to communicate with the second UE 604B (e.g., a half-duplex UE). For example, the first network entity 602A may transmit the DL transmission 608 to the second UE 604B at the same time that the first UE 604A transmits the UL transmission 610 to the first network entity 602A. At the same time, the first network entity 602A may transmit a DL transmission 620 to the first UE 604A. Accordingly, the DL transmission 608 or the DL transmission 620 may result in the network entity self-interference 612 at the first network entity 602A when the first network entity 602A is attempting to decode the UL transmission 610. In some aspects, the UL transmission 610 may result in a UE self-interference 622 at the first UE 604A when the first UE 604A is attempting to decode the DL transmission 620. Additionally, the UL transmission 610 may result in the inter-UE CLI 614 at the second UE 604B when the second UE 604B is attempting to decode the DL transmission 608. In some aspects, a DL transmission by the second network entity 602B may also result in the inter-network entity CLI 616 at the first network entity 602A when the first network entity 602A is attempting to decode the UL transmission 610.

In the third interference scenario 600C depicted in the example of FIG. 6C, the second network entity 602B may communicate with the first UE 604A (e.g., a full-duplex UE) and the second UE 604B (e.g., a half-duplex UE), where the first UE 604A uses the full-duplex communication 618 or the full-duplex configuration 624. As shown, the second network entity 602B may transmit a DL transmission 626 to the first UE 604A at the same time as transmitting a DL transmission 628 to the second UE 604B. At the same time, the first UE 604A may transmit the UL transmission 610 to the first network entity 602A. Accordingly, the UL transmission 610 may result in the UE self-interference 622 at the first UE 604A when the first UE 604A is attempting to decode the DL transmission 626. Additionally, the UL transmission 610 may result in the inter-UE CLI 614 at the second UE 604B when the second UE 604B is attempting to decode the DL transmission 628. In some aspects, the DL transmission 626 or the DL transmission 628 may result in the inter-network entity CLI 616 at the first network entity 602A when the first network entity 602A is attempting to decode the UL transmission 610. In some aspects, the first network entity 602A and the second network entity 602B may be different transmission and reception points (TRPs) of a same network entity, where the same network entity is a multi-TRP entity.

Various techniques may be used to mitigate the effects of the inter-network entity CLI 616 discussed above. In some examples, a network entity may conduct channel measurements to determine the CLI. For example, a network entity may conduct co-channel CLI measurements, CLI interference covariance matrix measurements, or other measurements. Based on these measurements, the network entities may cooperate (e.g., via appropriate signaling) to reduce the CLI at a given network entity when the network entity is attempting receive a transmission (e.g., from a UE). For example, the network entities may schedule their transmissions and/or receptions to avoid conflicts, adjust transmission parameters to mitigate the effects that transmissions by one network entity have on receptions at the other network entity, and so on.

To enhance the quality of the CLI-related measurements at a network entity discussed above, the network entity may cause the UEs served by the network entity to mute UL transmissions that could otherwise interfere with the CLI-related measurements. The UL resource muting can be used to enable a network entity to measure levels of the inter-network entity CLI 616 with less interference from the UL, to measure a channel between network entities with less interference from the UL, or to measure an interference covariance matrix for the inter-network entity CLI 616 with less interference from the UL. For example, for enhancement of measurement of the inter-network entity CLI 616 and/or channel measurement, two options may be used for UL resource muting. A first option involves a transparent UL resource muting method (e.g., avoid UL scheduling on the measurement resource). A second option involves a non-transparent UL resource muting method (e.g., define an UL resource muting pattern with one or more RE/RB muting patterns).

For UL muting, different UL blank/muting resources can be used to measure spatial characteristics of the inter-network entity CLI 616 caused by various DL signals and to avoid the inter-network entity CLI 616. The UL resources muting pattern can be different for various DL channel(s) or signal(s). For measurement of the inter-network entity CLI 616, one or more muting operations may be supported. For example, REs may be muted in an UL slot at the position of part of REs of an SSB, a first SIB (SIB1), and/or a broadcast PDCCH from an aggressor cell or network entity (e.g., a nearby network entity that causes the inter-network entity CLI 616) to enable the inter-network entity CLI 616 to indicate the spatial characteristics of DL broadcast interference. REs may be muted in an UL slot at the position of part of the REs of unicast PDSCH and PDCCH from the aggressor cell or network entity to enable measurement of the inter-network entity CLI 616 to obtain the spatial characteristics of unicast PDSCH and PDCCH CLI. REs may be muted in an UL slot at the position of the REs of non-zero power (NZP) CSI-RS (e.g., a CSI-RS transmitted with an amount of power greater than zero) from the aggressor cell or network entity to enable a network entity to avoid strong CLI.

### Aspects Related to PT-RS Transmissions

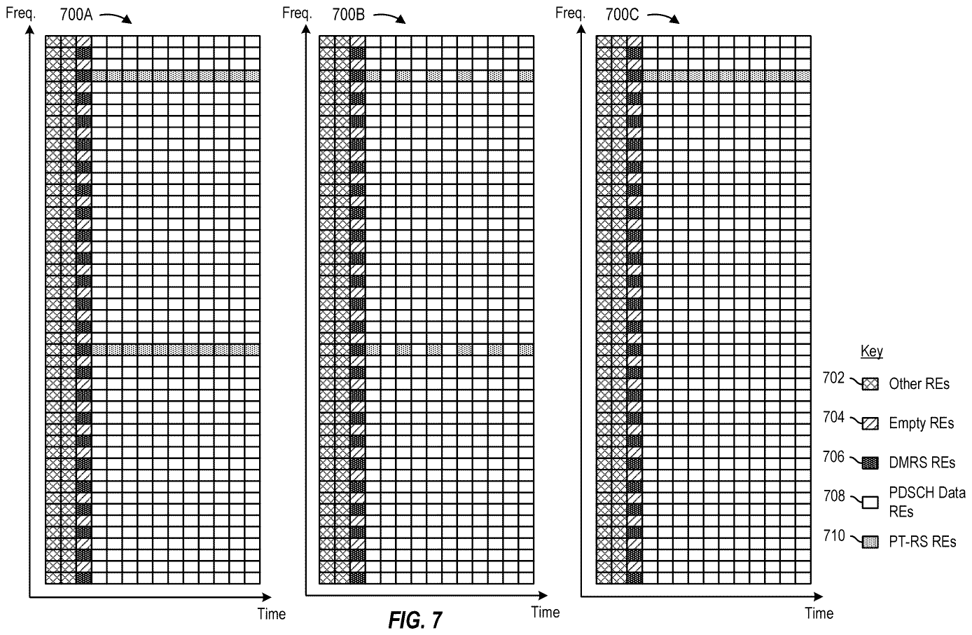

FIG. 7 depicts examples of PT-RS configurations. For example, FIG. 7 may include a first PT-RS configuration 700A, a second PT-RS configuration 700B, and a third PT-RS configuration 700C. In some aspects, the first PT-RS configuration 700A, the second PT-RS configuration 700B, and the third PT-RS configuration 700C may implement aspects of or may be implemented by aspects of FIGS. 1-6C. For example, a network entity or a UE may send a PT-RS according to the first PT-RS configuration 700A, the second PT-RS configuration 700B, or the third PT-RS configuration 700C. In some aspects, the network entity may be an example of the BS 102 depicted and described with respect to FIG. 1, the first network entity 300 or the second network entity 302 depicted and described with respect to FIG. 3, a disaggregated base station depicted and described with respect to FIG. 2, the network entity described with respect to FIGS. 5A-5C, or the first network entity 602A or the second network entity 602B depicted and described with respect to FIGS. 6A-6C. Similarly, the UE may be an example of the UE 104 depicted and described with respect to FIG. 1, the UE 304 depicted and described with respect to FIG. 3, the UE described with respect to FIGS. 5A-5C, or the first UE 604A or the second UE 604B depicted and described with respect to FIGS. 6A-6C. Additionally, the first PT-RS configuration 700A, the second PT-RS configuration 700B, and the third PT-RS configuration 700C may include aspects of the data structures for a wireless communications network depicted and described with respect to FIGS. 4A-4D.

As described previously, a PT-RS refers to a specific reference signal sent by a transmitting device (e.g., a network entity via a PDSCH or a UE via a PUSCH) in a wireless communications network and is designed to enable a receiving device to track the phase of received signals from the transmitting device. The PT-RS may enable the receiving device to mitigate effects of phase noise. For example, the phase noise of a transmitter of the transmitting device may increase as the frequency of operation increases. The PT-RS may enable the receiving device to minimize the effect of an oscillator phase noise on system performance. For example, the phase noise may introduce a common phase rotation of all subcarriers into an OFDM signal for messages sent by the transmitting device, where the common phase rotation includes or is referred to as CPE. Accordingly, the receiving device may use the PT-RS to estimate the CPE for mitigating the CPE for subsequent messages from the transmitting device. That is, the receiving device may use the PT-RS to estimate and minimize the effect of CPE on system performance.

In some aspects, due to phase noise properties, PT-RS may have a low density in the frequency domain and a high density in the time domain. For examples, a network entity may map PT-RS tones to a few subcarriers per symbol because the phase rotation affects all subcarriers within an OFDM symbol equally but shows low correlation from symbol to symbol. In some aspects, the network entity may configure the PT-RS depending on the quality of the oscillators, a carrier frequency, a subcarrier spacing (SCS), and MCSs that transmission of the message from the transmitting device uses. PT-RS may be associated with one DMRS port during transmission and may be confined to a scheduled bandwidth and duration used for messages from the transmitting device. In some aspects, PT-RS transmission may occur in combination with DMRS (e.g., PT-RS is transmitted in a same slot as DMRS).

In some aspects, PT-RS tones may be sent according to time and frequency densities specified (e.g., by the network entity) by parameters ‘L’ and ‘K,’ respectively. For example, for the time densities (e.g., values of ‘L’), L=1 may correspond to a PT-RS being sent on every PDSCH symbol, L=2 may correspond to a PT-RS being sent on one symbol every two PDSCH symbols, and L=4 may correspond to a PT-RS being sent on one symbol every four PDSCH symbols. For the frequency densities (e.g., value of ‘K’), K=4 may correspond to one PT-RS tone being sent every four RBs and K=2 may correspond to one PT-RS tone being sent every two RBs. In some aspects, the different frequency densities may include uniformly distributing the PT-RS tones over the frequency domain.

In the example of FIG. 7, the first PT-RS configuration 700A, the second PT-RS configuration 700B, and the third PT-RS configuration 700C may include a plurality of REs configured for different types of transmission. For example, the first PT-RS configuration 700A, the second PT-RS configuration 700B, and the third PT-RS configuration 700C may include one or more other REs 702 (e.g., REs configured to carry control information and/or other types of information), one or more empty REs 704 (e.g., REs configured to not include any signaling), one or more DMRS REs 706 (e.g., REs configured to carry a DMRS), one or more PDSCH data REs 708 (e.g., REs configured to carry PDSCH data), and one or more PT-RS REs 710. In the example of the first PT-RS configuration 700A, the one or more PT-RS REs 710 may be sent according to time and frequency densities of L=1 and K=2. In the example of the second PT-RS configuration 700B, the one or more PT-RS REs 710 may be sent according to time and frequency densities of L=2 and K=2. In the example of the third PT-RS configuration 700C, the one or more PT-RS REs 710 may be sent according to time and frequency densities of L=1 and K=4.

As described herein, while the examples of the first PT-RS configuration 700A, the second PT-RS configuration 700B, and the third PT-RS configuration 700C as illustrated in FIG. 7 are shown for a DL PT-RS transmission (e.g., from a network entity to a UE for the UE to estimate the CPE), the techniques and signaling may be extended to an UL PT-RS. For example, the network entity may configure the UE to send PT-RS in a PUSCH according to similar configurations as the first PT-RS configuration 700A, the second PT-RS configuration 700B, and the third PT-RS configuration 700C, but the one or more PDSCH data REs 708 may be one or more PUSCH data REs.

To enable UL PT-RS, the network entity may send a configuration to the UE for UL PT-RS transmission (e.g., PT-RS-UplinkConfig parameter). In some aspects, the network entity may send the configuration to the UE via higher layer signaling (e.g., RRC signaling). In the configuration, the network entity may indicate whether transform precoding is disabled or enabled for the UL PT-RS transmission (e.g., transformerPrecoderDisabled information element (IE) in the configuration or transformerPrecoderEnabled IE in the configuration). When transform precoding is disabled, a waveform configured for the UL PT-RS transmission may include a CP-OFDM waveform. When transform precoding is enabled, the waveform configured for the UL PT-RS transmission may include a discrete-Fourier-transform-spread OFDM (DFT-s-OFDM) waveform. With transform precoding, a frequency-domain signal may be reshaped into a time-domain signal (e.g., through a DFT).

Based on whether transform precoding is disabled or enabled for the UL PT-RS transmission, the configuration may include one or more additional parameters for the UL PT-RS transmission. For example, when transform precoding is disabled, the configuration may include a frequency density parameter (e.g., frequencyDensity IE to indicate a ‘K’ value as described previously), a time density parameter (e.g., timeDensity IE to indicate an ‘L’ value as described previously), a maximum number of PT-RS ports (e.g., maxNrofPorts IE to indicate a number of ports for the UE to use for the UL PT-RS transmission), an RE offset (e.g., resourceElementOffset IE to indicate a frequency offset for which RE(s) are to carry the PT-RS in a PUSCH with respect to a starting RE of an RB); and a transmission power for the UL PT-RS transmission (e.g., PTRS-Power IE). When transform precoding is enabled, the configuration may include a sample density (e.g., sampleDensity IE to indicate a frequency density including a number of PT-RS samples in a group and a number of PT-RS groups per OFDM symbol) and a time density (e.g., timeDensityTransformPrecoding IE to indicate an ‘L’ value as described previously).

For the UL PT-RS with transform precoding disabled (e.g., transmitted via a CP-OFDM waveform), one or two PT-RS port(s) can be scheduled (e.g., via the maxNrofPorts IE) for a UE based on one or more capabilities of the UE. The PT-RS ports may include physical transmit antenna ports of the UE or may include logical transmit antenna ports or virtual antenna ports that map to physical transmit antenna ports of the UE. In some aspects, two PT-RS ports can be used for non-coherent or partial-coherent UL transmission, with two local oscillators in the UE. If the UE has reported a capability of supporting full-coherent UL transmission, a single PT-RS port may be used. The number of scheduled PT-RS ports may be given by Qₚ (e.g., Qₚ={1,2} PT-RS port(s) in UL).

When the UE is scheduled with Qₚ PT-RS port(s) in the UL, the PT-RS power may be power boosted (e.g., increasing a transmission power of the UL PT-RS transmission based on a corresponding value) according to a number of PUSCH layers. The power boosting value may be different for different transmission schemes, such as which transmission codebook (e.g., full, partial, or non-coherent) is used. The power boosting value may be indicated by the PTRS-Power IE in the configuration for the UL PT-RS transmission (e.g., UL-PTRS-Power), where the PTRS-Power IE may include a value from the set of {00,01,10,11}. The different values for the PTRS-Power IE may indicate different options to be used for power boosting the UL PT-RS transmission and/or different UL PT-RS power boosting factors per PT-RS port. For example, Table 1 given below (e.g., Table 6.2.3.1-3 of 3GPP Technical Specification (TS) 38.214, version (v) 18.5.0) may indicate how the different values for the PTRS-Power IE correspond to the different options to be used for power boosting the UL PT-RS transmission and/or different UL PT-RS power boosting factors per PT-RS port.

TABLE 1
UL PT-RS Power Boosting in dB

| | | Number of PUSCH Layers | | | | | | |
|---|---|---|---|---|---|---|---|---|
| | | 2 | | 3 | | | | |
| | | | Partial | | Partial | 4 | | |
| | | | and Non- | | and Non- | | | Non- |
| UL- | | | Coherent | | Coherent | | | Coherent |
| PT- | 1 | | and Non- | | and Non- | | | and Non- |
| RS- | All | Full | Codebook | Full | Codebook | Full | Partial | Codebook |
| power | Cases | Coherent | Based | Coherent | Based | Coherent | Coherent | Based |
| 00 | 0 | 3 | 3Qₚ-3 | 4.77 | 3Qₚ-3 | 6 | 3Qₚ-3 | 3Qₚ-3 |
| 01 | 0 | 3 | 3 | 4.77 | 4.77 | 6 | 6 | 6 |

| | |
|---|---|
| 10 | Reserved |
| 11 | Reserved |

Using Table 1, the network entity may choose between indicating whether the UE is to apply PT-RS power boosting or not. For example, the ‘00’ value for the PTRS-Power IE may indicate for the UE to not apply PT-RS power boosting. If power boosting is not applied, there may be a slight variation in per-symbol power of a PUSCH of 0.1 or 0.2 dB (e.g., depending on the PT-RS density). There may also be a slight variation in per-symbol power for PUSCH layers without associated PT-RS ports. Additionally or alternatively, the ‘01’ value for the PTRS-Power IE may indicate for the UE to apply PT-RS power boosting (e.g., to mitigate variations in per-symbol power of the PUSCH).

### Aspects Related to Power Boosting for UL Muting

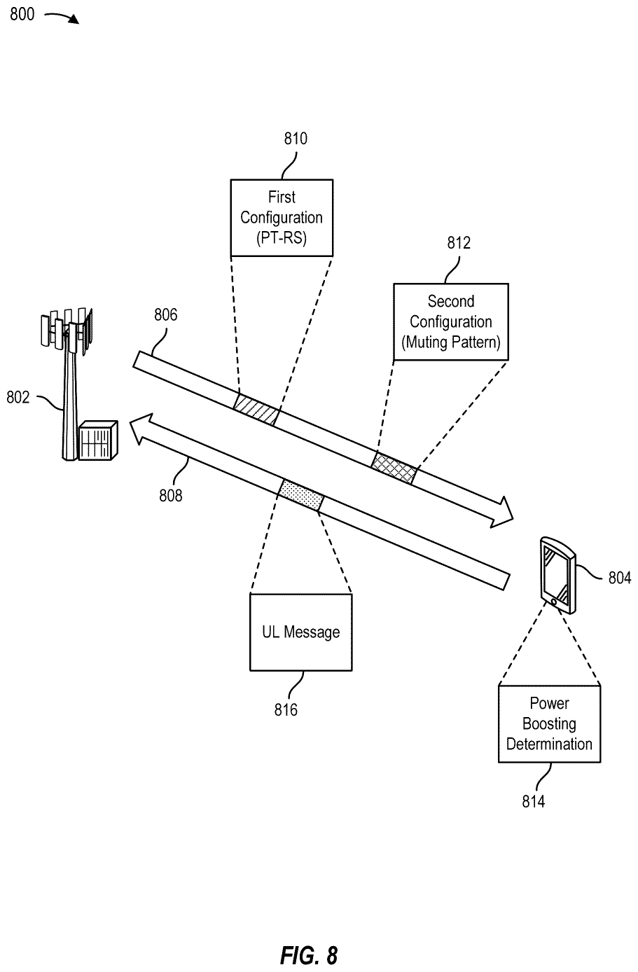

FIG. 8 depicts an example wireless communications network 800 that supports applying a power boosting to PT-RS REs and/or data REs in an UL message when one or more REs are muted in the UL message in accordance with aspects of the present disclosure. In some examples, the wireless communications network 800 may implement aspects of or may be implemented by aspects of FIGS. 1-7. For example, the wireless communications network 800 may include a network entity 802 and a UE 804. In some aspects, the network entity 802 may be an example of the BS 102 depicted and described with respect to FIG. 1, the first network entity 300 or the second network entity 302 depicted and described with respect to FIG. 3, a disaggregated base station depicted and described with respect to FIG. 2, the network entity described with respect to FIGS. 5A-5C, the network entities 602 depicted and described with respect to FIGS. 6A-6C, or the network entity described with respect to FIG. 7. Similarly, the UE 804 may be an example of the UE 104 depicted and described with respect to FIG. 1, the UE 304 depicted and described with respect to FIG. 3, the UE described with respect to FIGS. 5A-5C, the UEs 604 depicted and described with respect to FIGS. 6A-6C, or the UE described with respect to FIG. 7.

Additionally, the wireless communications network 800 may be an example of wireless communications network 100 and may support communication between the network entity 802 and the UE 804. For example, the network entity 802 and the UE 804 may wirelessly communicate via a communication link 806 (e.g., a DL communication link, one or more carriers, a communication link 120, etc.) and a communication link 808 (e.g., an UL communication link, one or more carriers, a communication link 120, etc.).

In some aspects, the network entity 802 may send a first configuration 810 to the UE 804 (e.g., via the communication link 806). The first configuration 810 may schedule transmission of a PT-RS by the UE 804 on one or more first REs of a first symbol (e.g., of a PUSCH). For example, the PT-RS may be transmitted as described with respect to FIG. 7 to enable the network entity 802 to estimate and mitigate CPE. The network entity 802 may also send a second configuration 812 to the UE 804 (e.g., via the communication link 806). The second configuration 812 may include a muting pattern for the first symbol. The muting pattern may indicate one or more second REs to be muted by the UE 804 on the first symbol. In some aspects, the network entity 802 may support full-duplex communications (e.g., as depicted and described with respect to FIGS. 5A-5C). For example, the network entity 802 may simultaneously communicate in the DL and in the UL on a set of same time-domain resources. As depicted and described previously (e.g., with respect to FIGS. 6A-6C), the full-duplex communications may cause CLI at the network entity 802 (e.g., inter-network entity CLI or inter-gNB CLI) and/or at the UE 804 (e.g., intra-band UE-to-UE CLI and/or inter-band UE-to-UE CLI). Accordingly, the second configuration 812 and the corresponding muting pattern may enable the network entity 802 to measure and mitigate the CLI.

Based on obtaining the first configuration 810 and the second configuration 812, the UE 804 may perform a power boosting determination 814 to determine whether to apply a power boosting to the one or more first REs for the PT-RS transmission and/or to one or more third REs, where the one or more third REs may include data REs (e.g., UL data REs) that are not muted according to the muting pattern (and do not include the PT-RS transmission). As part of the power boosting determination 814, if the UE 804 determines to apply the power boosting, the UE 804 may also determine a power boosting value and/or a power boosting factor to apply to the one or more first REs and/or the one or more third REs. In some aspects, the power boosting determination 814 may include the UE 804 determining a power boosting scheme associated with the PT-RS and the muting pattern.

In some aspects, the power boosting determination 814 may include the UE 804 applying a same power boosting value to both the one or more first REs and the one or more third REs. For example, the same power boosting value may be 3 dB. With this option of applying the same power boosting value to both the one or more first REs and the one or more third REs, the information in Table 1 given previously may not be changed. For example, this same power boosting value for the one or more first REs may be applied to the PT-RS transmission in addition to a power boosting corresponding to a PTRS-Power IE indicated in the first configuration 810 (e.g., if the PTRS-Power IE includes the ‘01’ value). If the PTRS-Power IE includes the ‘00’ value (e.g., no power boosting applied to the PT-RS according to the first configuration 810), a difference in transmission power may be observed for the one or more third REs for the UL data between symbol(s) with UL muting and symbol(s) without UL muting (e.g., 0.1 dB or 0.2 dB difference depending on the frequency density of the PT-RS indicated in the first configuration 810).

In some aspects, PT-RS power boosting may be defined relative to UL data. As such, in the above described option, for symbols with muted REs (e.g., indicated by the muting pattern in the second configuration 812), the one or more third REs for the UL data may be boosted by the same power boosting value (e.g., 3 dB), which corresponds to the PT-RS transmission also being boosted by the same power boosting value as the PT-RS power is relative to data. In such aspects, an energy per RE (EPRE) for the PT-RS transmission may different across symbols, such that a PT-RS receiver at the network entity 802 has to account for the different EPRE. For example, the EPRE for the PT-RS may have a first value on the first symbol and a second value on a second symbol, where the second value is different than the first value, and the network entity 802 may account for these different values when receiving the PT-RS from the UE 804.

Additionally or alternatively, the power boosting determination 814 may include the UE 804 applying a power boosting value (e.g., 3 dB) to the one or more third REs and keeping a transmission power for the one or more first REs for the PT-RS the same (e.g., according to the PTRS-Power IE in the first configuration 810 and corresponding entry in Table 1). With this option, a ratio defined for PT-RS power boosting (e.g., according to Table 1) may be defined based on a transmission power for the one or more third REs for UL data transmission before applying the power boosting value.

Subsequently, for this option, a transmission power of the UL data for symbol(s) with UL muting (e.g., according to the muting pattern) may be lower than symbol(s) without UE muting. For example, an amount of the one or more third REs for UL data in symbol(s) with UL muting may be less than an amount of the one or more third REs for UL data in symbol(s) without UL muting, where the amount of the one or more third REs for UL data in the symbol(s) with UL muting is less than half of the total REs in those symbols (e.g., based on one or more REs originally allocated for UL data being used for the PT-RS transmission instead in addition to the muted REs). The difference in transmission power for the one or more third REs may depend (e.g., a 0.3 dB to 0.6 dB total difference) on a frequency density for the PT-RS indicated in the first configuration 810. Additionally or alternatively, if the PTRS-Power IE includes the ‘00’ value (e.g., no power boosting applied to the PT-RS according to the first configuration 810), an additional difference in transmission power may be observed for the one or more third REs for the UL data between symbol(s) with UL muting and symbol(s) without UL muting (e.g., 0.1 dB or 0.2 dB difference depending on the PT-RS density when the PTRS-Power IE includes the ‘00’ value). The EPRE for the PT-RS may be the same across symbols.

Additionally or alternatively, the power boosting determination 814 may include the UE 804 not applying a power boosting to the one or more first REs for the PT-RS and applying a power boosting factor to the one or more third REs for the UL data. For example, the power boosting factor for the one or more third REs may be determined according to Formula 1:

$$10 * log 10 [ ( N / 2 - 1 ) / ( N ) ] \qquad ( 1 )$$

where N=24 or 48 when a frequency density for the PT-RS (e.g., indicated in the first configuration 810) is per two RBs (e.g., K=2) or per four RBs (e.g., K=4), respectively. For N=24 (e.g., when K=2), the power boosting factor for the one or more third REs may equal a power boosting value of 3.4 dB (e.g., 10*log 10 [(24/2−1)/(24)]=10*log 10 [11/24]=−3.39 dB, corresponding to the 3.4 dB power boosting value). For N=48 (e.g., when K=4), the power boosting factor for the one or more third REs may equal a power boosting value of 3.2 dB (e.g., 10*log 10 [(48/2−1)/(48)]=10*log 10 [23/48]=−3.195 dB, corresponding to the 3.2 dB power boosting value).

Additionally or alternatively, the power boosting determination 814 may include the UE 804 applying a power boosting value (e.g., 3 dB) to the one or more third REs for the UL data and applying a power boosting factor to the one or more first REs for the PT-RS to maintain a same per-symbol power.

After performing the power boosting determination 814, the UE 804 may send an UL message 816 to the network entity 802 (e.g., via the communication link 808). For example, the UE 804 may send the UL message 816 according to a power boosting scheme associated with the PT-RS and the muting pattern (e.g., based on the power boosting determination 814). Additionally, the UL message 816 may include the PT-RS scheduled by the first configuration 810 (e.g., on the one or more first REs of the first symbol), the muting pattern indicated by the second configuration 812 (e.g., on the one or more second REs of the first symbol), and the UL data (e.g., on the one or more third REs of the first symbol). Accordingly, the UL message 816 may include a plurality of symbols that include at least the first symbol described herein.

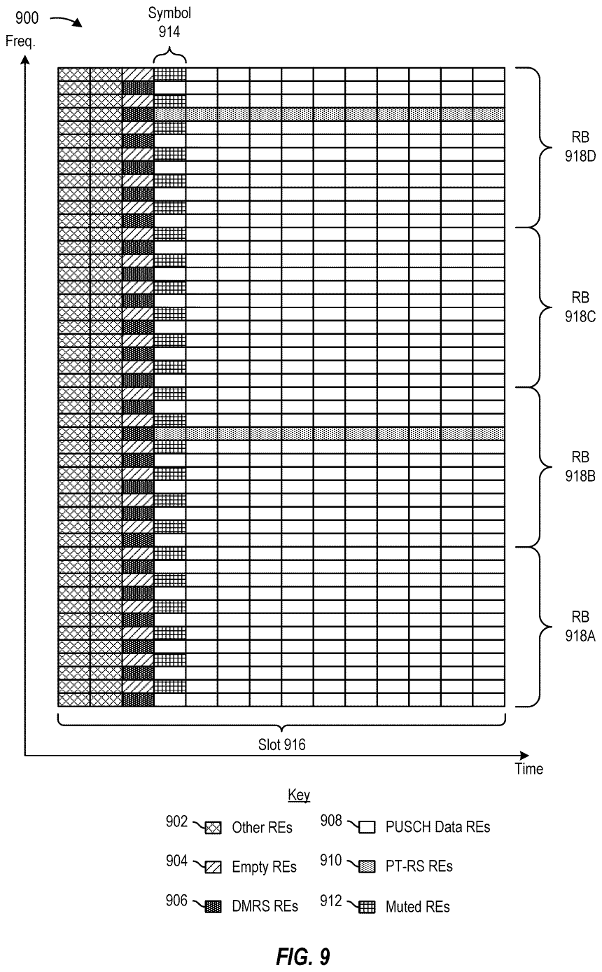

FIG. 9 depicts an example PT-RS configuration 900 with muted resource REs in accordance with aspects of the present disclosure. In some examples, the PT-RS configuration 900 may implement aspects of or may be implemented by aspects of FIGS. 1-8. For example, a UE may send an UL message according to the PT-RS configuration 900 based on signaling from a network entity. In some aspects, the network entity may be an example of the BS 102 depicted and described with respect to FIG. 1, the first network entity 300 or the second network entity 302 depicted and described with respect to FIG. 3, a disaggregated base station depicted and described with respect to FIG. 2, the network entity described with respect to FIGS. 5A-5C, the network entities 602 depicted and described with respect to FIGS. 6A-6C, the network entity described with respect to FIG. 7, or the network entity 802 depicted and described with respect to FIG. 8. Similarly, the UE may be an example of the UE 104 depicted and described with respect to FIG. 1, the UE 304 depicted and described with respect to FIG. 3, the UE described with respect to FIGS. 5A-5C, the UEs 604 depicted and described with respect to FIGS. 6A-6C, the UE described with respect to FIG. 7, or the UE 804 depicts and described with respect to FIG. 8.

In some aspects, the PT-RS configuration 900 may be similar to the first PT-RS configuration 700A, the second PT-RS configuration 700B, and/or the third PT-RS configuration 700C depicted and described with respect to FIG. 7. For example, as shown in the example of FIG. 9, the PT-RS configuration 900 may include one or more other REs 902 (e.g., similar to the one or more other REs 702 of FIG. 7), one or more empty REs 904 (e.g., similar to the one or more empty REs 704 of FIG. 7), one or more DMRS REs 906 (e.g., similar to the one or more DMRS REs 706 of FIG. 7), one or more PUSCH data REs 908 (e.g., similar to the one or more PDSCH data REs 708 of FIG. 7 but used for UL data transmission(s) via a PUSCH), and one or more PT-RS REs 910 (e.g., similar to the one or more PT-RS REs 710 of FIG. 7). In accordance with aspects of the present disclosure, the PT-RS configuration 900 may also include one or more muted REs 912.

Additionally, the UL message that is sent according to the PT-RS configuration 900 may represent an example of the UL message 816 depicted and described with respect to FIG. 8. Accordingly, the network entity may send one or more configurations to the UE for indicating the PT-RS configuration 900 for the UL message. For example, the network entity may send a first configuration to indicate the one or more PT-RS REs 910 (e.g., the first configuration 810 depicted and described with respect to FIG. 8). In the example of FIG. 9, the one or more PT-RS REs 910 may be allocated in the PT-RS configuration 900 according to a frequency density of K=2 (e.g., indicated by the first configuration), such that a PT-RS is sent every two RBs in the UL message. For example, the one or more PT-RS REs 910 may be allocated in a second RB 918B and a fourth RB 918D for the UL message according to the PT-RS configuration 900, and no REs in a first RB 918A or a third RB 918C may be allocated for the PT-RS. Additionally, in the example of FIG. 9, the one or more PT-RS REs 910 may be allocated in the PT-RS configuration 900 according to a time density of L=1 (e.g., indicated by the first configuration), such that the PT-RS is sent on every symbol of a slot 916 for the UL message (e.g., and any additional slots configured for the UL message). Accordingly, using these examples of the frequency density and the time density for the PT-RS, the one or more PT-RS REs 910 may be allocated on every symbol of one or more slots (e.g., including the slot 916) in the second RB 918B and the fourth RB 918D for the UL message.

Similarly, the network entity may send a second configuration to indicate the one or more muted REs 912 (e.g., the second configuration 812 depicted and described with respect to FIG. 8). As described previously, the network entity may indicate a resource muting pattern via the second configuration for the UL message to configure the one or more muted REs 912, where the one or more muted REs 912 are used for CLI mitigation (e.g., inter-network entity or inter-gNB CLI). For example, the resource muting pattern may indicate the one or more muted REs 912 on a PUSCH (e.g., a dynamic grant (DG) PUSCH and/or a Type 2 configured grant (CG) PUSCH) that the UE is to mute and/or that the UE is to refrain from sending signaling, and the network entity may use the one or more muted REs 912 for CLI measurements and mitigation.

In some aspects, when a network entity indicates for a UE to send one or more muted resources (e.g., on the one or more muted REs 912), the network entity may configure (e.g., in the second configuration) a time location configuration of the one or more muted REs 912 for the PUSCH using one of multiple different possible options. For example, the network entity may semi-statically configure a position for each UL muting symbol of up to two UL muting symbols within a slot. In some aspects, the semi-statically configured position for each UL muting symbol may be referred to as a single resource muting pattern. Additionally or alternatively, the network entity may semi-statically configure a value, X (where X≥1), that indicates a number of possible positions for each UL muting symbol of the up to two UL muting symbols within a slot. In some aspects, the number of possible positions for each UL muting symbol may be referred to as multiple resource muting patterns. For both of these options, there will be up to two UL muting symbols for the UE to apply resource muting when sending a PUSCH.

Additionally, for the UL resource muting symbol(s), the network entity may semi-statically configure each time position of the muted symbol(s) (e.g., either for the single resource muting pattern or for the multiple resource muting patterns) and may dynamically select and indicate one resource muting pattern to the UE by a downlink control indication (DCI) message. In some aspects, for the single resource muting pattern option, the network entity may not dynamically indicate which pattern is selected in the DCI message but may dynamically activate or deactivate the single resource muting pattern via the DCI message (e.g., via a time-domain resource allocation (TDRA) field in the DCI message).

In some aspects, a reference point may be configured and/or defined for the UE to determine a time location of the UL resource muting for a PUSCH. For example, the reference point may include a starting symbol of a slot for the PUSCH for both PUSCH mapping type A (e.g., the starting symbol is fixed to symbol ‘0’ of a slot for the PUSCH) and PUSCH mapping type B (e.g., the starting symbol can be flexibly configured from symbol ‘0’ to symbol ‘12’ or from symbol ‘0’ to symbol ‘13’ of a slot for the PUSCH). For example, the network entity may indicate one or more patterns dedicated to resource muting (e.g., resource muting patterns) to the UE, and the one or more resource muting patterns may indicate the resources to be muted by the UE in the up to two UL muting symbols within a slot. In the example of FIG. 9, the one or more muted REs 912 may be configured (e.g., via the second configuration according to one of the options described above) to occur in a symbol 914 of the slot 916.

Additionally, according to the second configuration, the resource muting pattern may include an assumption and/or indication of a comb-2 type frequency allocation of the one or more muted REs 912 for both DFT-S-OFDM (e.g., if transform precoding is enabled) and CP-OFDM (e.g., if transform precoding is disabled) in each allocated PRB of the PUSCH for the UL message. For example, the comb-2 type frequency allocation may correspond to the UE muting an RE on every other (e.g., every second) subcarrier for each allocated PRB. That is, in the PT-RS configuration 900, each RE of the one or more muted REs 912 may occur on every other subcarrier of each of the first RB 918A, the second RB 918B, the third RB 918C, and the fourth RB 918D in the symbol 914. In some aspects, for the frequency allocation for the one or more muted REs 912, a comb offset of {0, 1} may be configured for the up to two UL muting symbols (e.g., at least for a CP-OFDM waveform for the PUSCH).

In some aspects, power boosting may be assumed for PUSCH data REs in a symbol that includes muted REs, such that a PUSCH transmit power does not change across symbols (e.g., across both symbols with muted REs and symbols without muted REs). For example, a 3 dB power boosting may be assumed for the PUSCH data REs in symbol(s) with muted REs and that do not include a PT-RS. That is, without the power boosting, symbols that include muted REs may have a lower PUSCH transmit power than symbols that do not include muted REs because fewer REs that carry signaling are transmitted in the symbol(s) that include muted REs. As such, the power boosting may increase a transmit power on the PUSCH data REs in symbols with muted REs to maintain a same PUSCH transmit power across both symbols with muted REs and symbols without muted REs. In some aspects, this power boosting assumption may be based on a ratio of PUSCH data REs to a total number of REs in symbols with muted REs is equal to 0.5 (e.g., half of the REs in such symbols are allocated to the PUSCH data REs and the other half of the REs in such symbols are muted).

Additionally, the UE may assume that the one or more muted REs 912 do not overlap with the one or more DMRS REs 906 and/or the one or more PT-RS REs 910 in a same symbol (e.g., the symbol 914). Additionally or alternatively, the network entity may configure and schedule the one or more muted REs 912 to not overlap with the one or more DMRS REs 906 and/or the one or more PT-RS REs 910 in a same symbol. Accordingly, if both muted REs and PT-RS REs are located in a same symbol, the power boosting assumption described above may result in a difference in PUSCH transmit power across symbols. For example, the one or more PT-RS REs 910 may occupy REs originally allocated for the one or more PUSCH data REs 908 based on the assumption that the one or more muted REs 912 do not overlap with the one or more DMRS REs 906 and/or the one or more PT-RS REs 910 (e.g., the one or more PT-RS REs 910 cannot occupy an RE configured for the one or more muted REs 912). As such, the power boosting assumption of the one or more PUSCH data REs 908 may still result in a lower PUSCH transmit power for the symbol(s) with muted REs and PT-RS than for symbols without muted REs (e.g., and optionally PT-RS) because fewer PUSCH data REs are sent in the symbol(s) with muted REs and PT-RS.

Based on the example of FIG. 9 with a PT-RS every other RB 918, for symbols without RE muting, 23 REs may be allocated for the one or more PUSCH data REs 908 per two RBs in each symbol, and one RE may be allocated for the one or more PT-RS REs 910 per two RBs in each symbol. Alternatively, for symbols with RE muting, 12 REs may be allocated for the one or more muted REs 912 per two RBs in each symbol, 11 REs may be allocated for the one or more PUSCH data REs 908 per two RBs in each symbol, and one RE may be allocated for the one or more PT-RS REs 910 per two RBs in each symbol. Accordingly, for the symbols with RE muting, a ratio of the REs allocated for the one or more PUSCH data REs 908 (e.g., 11 REs) to a total number of REs per two RBs (e.g., 24 REs) in each symbol is less than 0.5 (e.g., 11/24=0.458). Subsequently, for the power boosting assumption described above, the ratio of the REs allocated for the one or more PUSCH data REs 908 to the total number of REs per two RBs in each symbol may not be the same anymore, resulting in different PUSCH transmit powers across symbols.

As such, the UE may boost the transmit power by 3 dB combined across the 12 REs that include the 11 REs allocated to the one or more PUSCH data REs 908 and the one RE allocated to the one or more PT-RS REs 910 in each symbol to maintain a PUSCH transmit power across symbols with PT-RS and with or without resource muting. As described herein, the UE may perform a power boosting determination (e.g., the power boosting determination 814 depicted and described with respect to FIG. 8) to maintain the PUSCH transmit power across symbols with PT-RS and with or without resource muting.

### Example Signaling for Power Boosting for PT-RS Transmissions with UL Muting

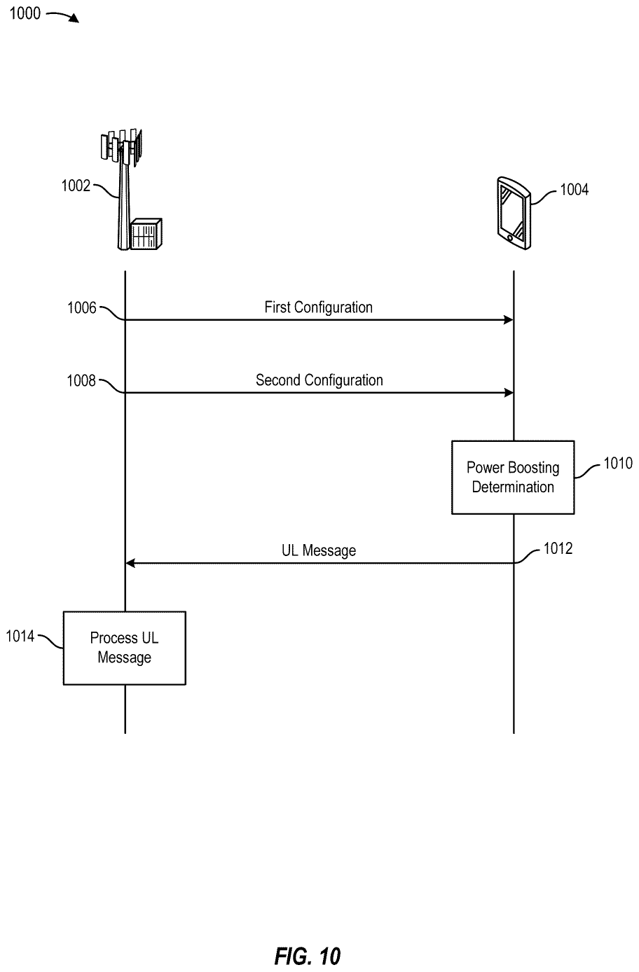

FIG. 10 depicts a process flow 1000 for communications in a network between a network entity 1002, a UE 1004. In some aspects, the process flow 1000 may implement aspects of or may be implemented by aspects of FIGS. 1-9. For example, the network entity 1002 may be an example of the BS 102 depicted and described with respect to FIG. 1, the first network entity 300 or the second network entity 302 depicted and described with respect to FIG. 3, a disaggregated base station depicted and described with respect to FIG. 2, the network entity described with respect to FIGS. 5A-5C, the network entities 602 depicted and described with respect to FIGS. 6A-6C, the network entity described with respect to FIG. 7, the network entity 802 depicted and described with respect to FIG. 8, or the network entity described with respect to FIG. 9. Similarly, the UE 1004 may be an example of the UE 104 depicted and described with respect to FIG. 1, the UE 304 depicted and described with respect to FIG. 3, the UE described with respect to FIGS. 5A-5C, the UEs 604 depicted and described with respect to FIGS. 6A-6C, the UE described with respect to FIG. 7, the UE 804 depicted and described with respect to FIG. 8, or the UE described with respect to FIG. 9. However, in other aspects, UE 1004 may be another type of wireless communications device and network entity 1002 may be another type of network entity or network node, such as those described herein. Note that any operations or signaling illustrated with dashed lines may indicate that that operation or signaling is an optional or alternative example.

At 1006, the network entity 1002 sends and the UE 1004 obtains a first configuration (e.g., the first configuration 810 depicted and described with respect to FIG. 8) that schedules transmission of a PT-RS on one or more first REs of a first symbol.

At 1008, the network entity 1002 sends and the UE 1004 obtains a second configuration (e.g., the second configuration 812 depicted and described with respect to FIG. 8) that includes a muting pattern for the first symbol, the muting pattern indicating one or more second REs to be muted on the first symbol. In some aspects, the one or more first REs and the one or more second REs may not overlap with one another in the first symbol.

At 1010, the UE 1004 determines a power boosting scheme associated with the PT-RS and the muting pattern (e.g., the power boosting determination 814 depicted and described with respect to FIG. 8). In some aspects, the power boosting scheme may indicate a same power boosting value for the one or more first REs and for one or more third REs of the first symbol, where the one or more third REs include data REs (e.g., PUSCH data REs) that are not muted according to the muting pattern. For example, the same power boosting value may be 3 dB. In such aspects, an EPRE for the PT-RS may have a first value on the first symbol and a second value on a second symbol, where the second value is different than the first value.

Additionally or alternatively, the power boosting scheme may indicate a first power boosting value for the one or more third REs of the first symbol and a second power boosting value for the one or more first REs. For example, the first power boosting value may be 3 dB, and the second power boosting value may be based on a PT-RS power boost indicated in the first configuration, where the PT-RS power boost is based on a transmission power for the one or more third REs before the first power boosting value. In such aspects, an EPRE for the PT-RS may be the same across a plurality of symbols that includes the first symbol.

Additionally or alternatively, the power boosting scheme may indicate a power boosting factor for the one or more third REs of the first symbol, and the one or more first REs may not be power boosted. For example, the power boosting factor may be based on a PT-RS density indicated in the first configuration.

Additionally or alternatively, the power boosting scheme may indicate a power boosting value for the one or more third REs of the first symbol and a power boosting factor for the one or more first REs. For example, the power boosting value may be 3 dB, and the power boosting factor may be associated with a same per-symbol power across a plurality of symbols that includes the first symbol.

At 1012, the UE 1004 sends and the network entity 1002 obtains (e.g., according to the determined power boosting scheme) an UL message (e.g., the UL message 816 depicted and described with respect to FIG. 8) on the first symbol in accordance with the PT-RS and the muting pattern. In some aspects, the UL message may include a CP-OFDM waveform.

At 1014, the network entity 1002 processes the UL message obtained at 1012. For example, the network entity 1002 may process the UL message to obtain the PT-RS from the UL message (e.g., to estimate and mitigate CPE) and to measure and mitigate any CLI experienced by the network entity 1002 based on the muting pattern for the UL message. In some aspects, if the EPRE for the PT-RS is different across symbols, a PT-RS receiver at the network entity 1002 may account for the different EPRE when processing the UL message. The network entity 1002 may also process the UL message and the one or more third REs (e.g., data REs) to obtain UL data sent by the UE 1004.

Note that the process flow illustrated in FIG. 10 is an example of a power boosting scheme, and aspects of the present disclosure may be applied to power boosting one or more REs of an UL message with UL muting. Note that the process flow illustrated in FIG. 10 is described herein to facilitate an understanding of applying a power boosting to PT-RS REs and/or data REs in an UL message when one or more REs are muted in the UL message, and aspects of the present disclosure may be performed in various manners via alternative or additional signaling and/or operations. In certain aspects, the operations and/or signaling of FIG. 10 may occur in an order different from that described or depicted, and various actions, operations, and/or signaling may be added, omitted, or combined.

### Example Operations of a User Equipment

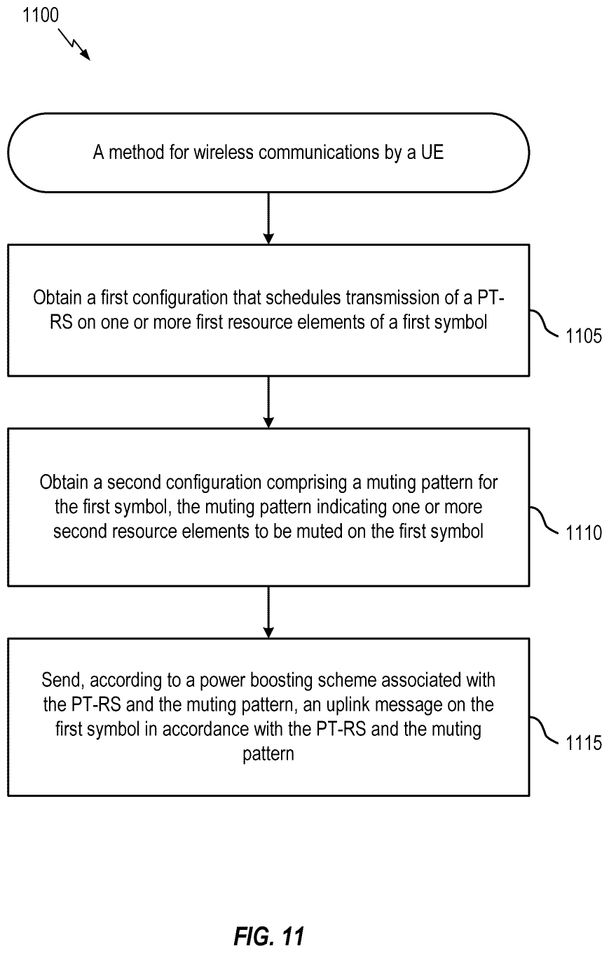

FIG. 11 shows a method 1100 for wireless communications by an apparatus, such as UE 104 of FIG. 1 or UE 304 of FIG. 3.

Method 1100 begins at block 1105 with obtaining a first configuration (e.g., the first configuration 810 depicted and described with respect to FIG. 8) that schedules transmission of a PT-RS on one or more first resource elements of a first symbol.

Method 1100 then proceeds to block 1110 with obtaining a second configuration (e.g., the second configuration 812 depicted and described with respect to FIG. 8) comprising a muting pattern for the first symbol, the muting pattern indicating one or more second resource elements to be muted on the first symbol.

Method 1100 then proceeds to block 1115 with sending, according to a power boosting scheme associated with the PT-RS and the muting pattern (e.g., determined according to the power boosting determination 814 depicted and described with respect to FIG. 8), an uplink message (e.g., the UL message 816 depicted and described with respect to FIG. 8) on the first symbol in accordance with the PT-RS and the muting pattern.

In some aspects, the power boosting scheme indicates a same power boosting value for the one or more first resource elements and for one or more third resource elements of the first symbol, and the one or more third resource elements comprise data resource elements that are not muted according to the muting pattern.

In some aspects, the same power boosting value comprises three decibels.

In some aspects, an EPRE for the PT-RS has a first value on the first symbol and a second value on a second symbol, wherein the second value is different than the first value.

In some aspects, the power boosting scheme indicates a first power boosting value for one or more third resource elements of the first symbol and a second power boosting value for the one or more first resource elements, and the one or more third resource elements comprise data resource elements that are not muted according to the muting pattern.

In some aspects, the first power boosting value comprises three decibels.

In some aspects, the second power boosting value is based on a PT-RS power boost indicated in the first configuration, and the PT-RS power boost is based on a transmission power for the one or more third resource elements before the first power boosting value.

In some aspects, an EPRE for the PT-RS is the same across a plurality of symbols, and the plurality of symbols comprises the first symbol.

In some aspects, the power boosting scheme indicates a power boosting factor for one or more third resource elements of the first symbol, and the one or more third resource elements comprise data resource elements that are not muted according to the muting pattern.

In some aspects, the power boosting factor is based on a PT-RS density indicated in the first configuration.

In some aspects, the one or more first resource elements are not power boosted.

In some aspects, the power boosting scheme indicates a power boosting value for one or more third resource elements of the first symbol and a power boosting factor for the one or more first resource elements, and the one or more third resource elements comprise data resource elements that are not muted according to the muting pattern. In some aspects, the power boosting value comprises three decibels.

In some aspects, the power boosting factor is associated with a same per-symbol power across a plurality of symbols, and the plurality of symbols comprise the first symbol.

In some aspects, the one or more first resource elements and the one or more second resource elements do not overlap with one another in the first symbol.

In some aspects, the uplink message comprises a CP-OFDM waveform.

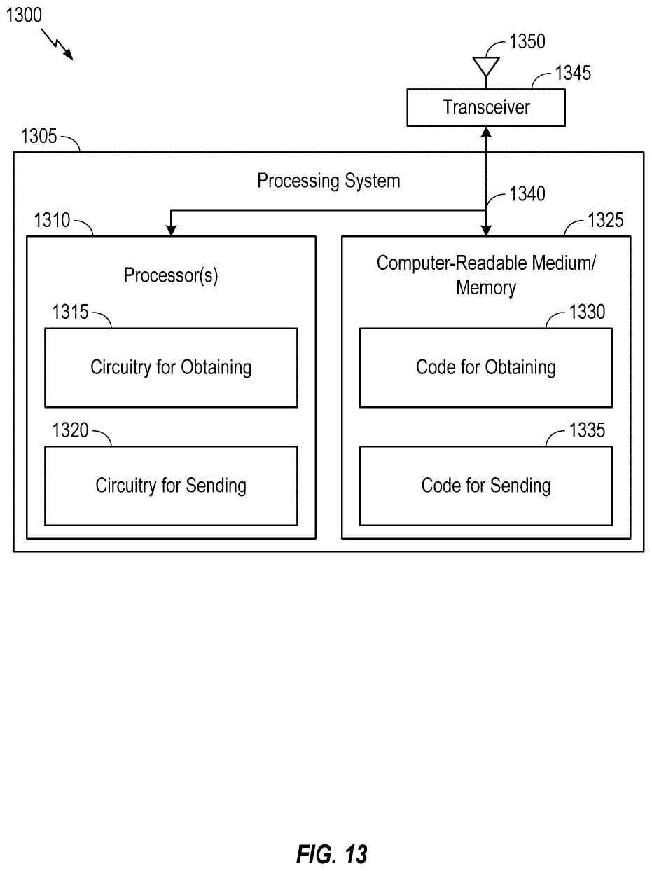

In some aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

In certain aspects, method 1100 may be performed by the apparatus to realize one or more technical effects or solutions to the aforementioned technical problem(s). For example, based on method 1100, the techniques for using a power boosting scheme for an UL message that is configured with UL resource muting and configured to carry a PT-RS may enable the apparatus to maintain a PUSCH transmit power or to reduce a difference of PUSCH transmit powers between symbols with the UL resource muting and symbols without the UL resource muting for the UL message that is also configured to carry the PT-RS. By maintaining the PUSCH transmit power or reducing a difference of PUSCH transmit powers between symbols with the UL resource muting and symbols without the UL resource muting for the UL message that is also configured to carry the PT-RS, the apparatus may increase a reliability that the UL message is successfully received and decoded by a network entity, thereby increasing communication reliability.

### Example Operations of a Network Entity

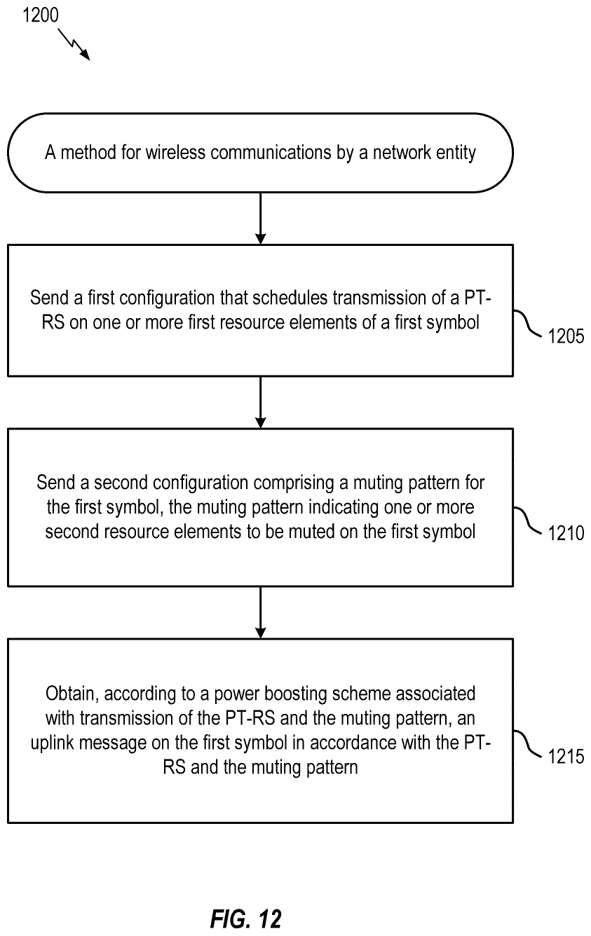

FIG. 12 shows a method 1200 for wireless communications by an apparatus, such as BS 102 of FIG. 1, a first network entity 300 or second network entity 302 of FIG. 3, or a disaggregated base station as discussed with respect to FIG. 2.

Method 1200 begins at block 1205 with sending a first configuration (e.g., the first configuration 810 depicted and described with respect to FIG. 8) that schedules transmission of a PT-RS on one or more first resource elements of a first symbol.

Method 1200 then proceeds to block 1210 with sending a second configuration (e.g., the second configuration 812 depicted and described with respect to FIG. 8) comprising a muting pattern for the first symbol, the muting pattern indicating one or more second resource elements to be muted on the first symbol.

Method 1200 then proceeds to block 1215 with obtaining, according to a power boosting scheme associated with transmission of the PT-RS and the muting pattern (e.g., determined according to the power boosting determination 814 depicted and described with respect to FIG. 8), an uplink message (e.g., the UL message 816 depicted and described with respect to FIG. 8) on the first symbol in accordance with the PT-RS and the muting pattern.

In some aspects, the power boosting scheme indicates a same power boosting value for the one or more first resource elements and for one or more third resource elements of the first symbol, and the one or more third resource elements comprise data resource elements that are not muted according to the muting pattern.

In some aspects, the same power boosting value comprises three decibels.

In some aspects, an EPRE for the PT-RS has a first value on the first symbol and a second value on a second symbol, wherein the second value is different than the first value.

In some aspects, the power boosting scheme indicates a first power boosting value for one or more third resource elements of the first symbol and a second power boosting value for the one or more first resource elements, and the one or more third resource elements comprise data resource elements that are not muted according to the muting pattern.

In some aspects, the first power boosting value comprises three decibels.

In some aspects, the second power boosting value is based on a PT-RS power boost indicated in the first configuration, and the PT-RS power boost is based on a transmission power for the one or more third resource elements before the first power boosting value.

In some aspects, an EPRE for the PT-RS is the same across a plurality of symbols, and the plurality of symbols comprises the first symbol.

In some aspects, the power boosting scheme indicates a power boosting factor for one or more third resource elements of the first symbol, and the one or more third resource elements comprise data resource elements that are not muted according to the muting pattern.

In some aspects, the power boosting factor is based on a PT-RS density indicated in the first configuration.

In some aspects, the one or more first resource elements are not power boosted.

In some aspects, the power boosting scheme indicates a power boosting value for one or more third resource elements of the first symbol and a power boosting factor for the one or more first resource elements, and the one or more third resource elements comprise data resource elements that are not muted according to the muting pattern. In some aspects, the power boosting value comprises three decibels.

In some aspects, the power boosting factor is associated with a same per-symbol power across a plurality of symbols, and the plurality of symbols comprise the first symbol.

In some aspects, the one or more first resource elements and the one or more second resource elements do not overlap with one another in the first symbol.

In some aspects, the uplink message comprises a CP-OFDM waveform.

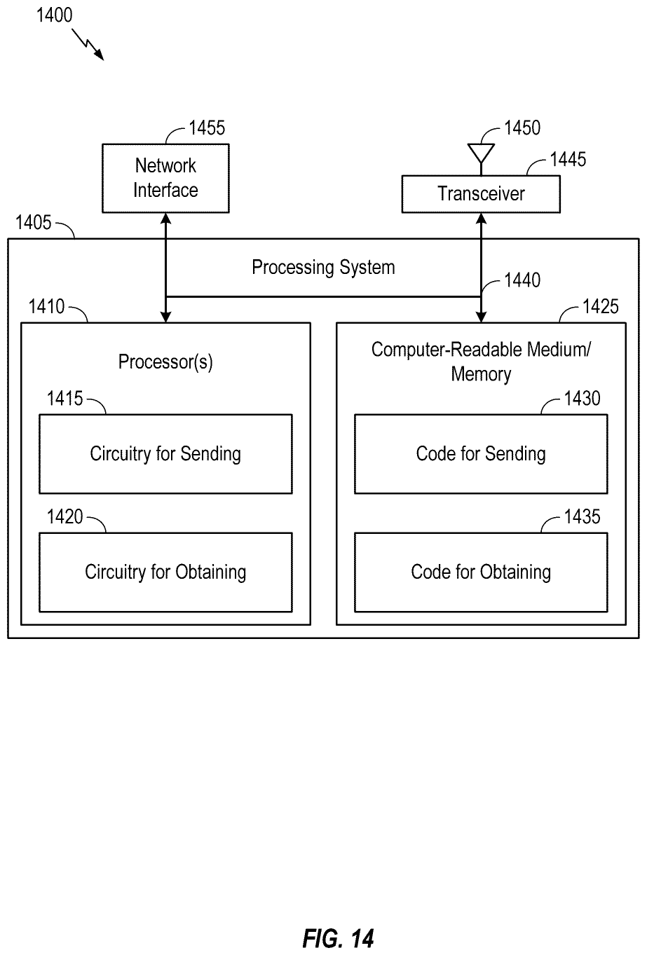

In some aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

In certain aspects, method 1200 may be performed by the apparatus to realize one or more technical effects or solutions to the aforementioned technical problem(s). For example, based on method 1200, the techniques for using a power boosting scheme for an UL message that is configured with UL resource muting and configured to carry a PT-RS may enable a UE to maintain a PUSCH transmit power or to reduce a difference of PUSCH transmit powers between symbols with the UL resource muting and symbols without the UL resource muting for the UL message that is also configured to carry the PT-RS. By maintaining the PUSCH transmit power or reducing a difference of PUSCH transmit powers between symbols with the UL resource muting and symbols without the UL resource muting for the UL message that is also configured to carry the PT-RS, the UE may increase a reliability that the UL message is successfully received and decoded by the apparatus, thereby increasing communication reliability.

### Example Communications Devices

FIG. 13 depicts aspects of an example communications device 1300 configured for wireless communications. In some aspects, communications device 1300 is a user equipment, such as UE 104 described above with respect to FIG. 1 or UE 304 described with respect to FIG. 3.

The communications device 1300 includes a processing system 1305 coupled to a transceiver 1345 (e.g., a transmitter and/or a receiver). The transceiver 1345 is configured to transmit and receive signals for the communications device 1300 via an antenna 1350, such as the various signals as described herein. The processing system 1305 may be configured to perform processing functions for the communications device 1300, including processing signals received and/or to be transmitted by the communications device 1300.

The processing system 1305 includes one or more processors 1310 and a computer-readable medium/memory 1325. In various aspects, the one or more processors 1310 may be representative of the one or more processors 318 described with respect to FIG. 3. The one or more processors 1310 are coupled to a computer-readable medium/memory 1325 via a bus 1340. In some aspects, the computer-readable medium/memory 1325 may be representative of the one or more memories 320 described with respect to FIG. 3. The computer-readable medium/memory 1325 is a non-transitory computer-readable medium/memory. In certain aspects, the computer-readable medium/memory 1325 is configured to store instructions (e.g., computer-executable code), that when executed by the one or more processors 1310, cause the one or more processors 1310 to perform the method 1100 described with respect to FIG. 11, or any aspect related to it, including any operations described in relation to FIG. 11. Note that reference to a processor performing a function of communications device 1300 may include one or more processors performing that function of communications device 1300, such as in a distributed fashion.

In the depicted example, computer-readable medium/memory 1325 stores code (e.g., executable instructions), including code for obtaining 1330 and code for sending 1335. Processing of the code 1330 and 1335 may enable and cause the communications device 1300 to perform the method 1100 described with respect to FIG. 11, or any aspect related to it. For instance, in some aspects, code for obtaining 1330 includes code for obtaining a first configuration that schedules transmission of a PT-RS on one or more first resource elements of a first symbol. In some aspects, code for obtaining 1330 includes code for obtaining a second configuration comprising a muting pattern for the first symbol, the muting pattern indicating one or more second resource elements to be muted on the first symbol. In some aspects, code for sending 1335 includes code for sending, according to a power boosting scheme associated with the PT-RS and the muting pattern, an uplink message on the first symbol in accordance with the PT-RS and the muting pattern.

The one or more processors 1310 include circuitry configured to implement (e.g., execute) the code stored in the computer-readable medium/memory 1325, including circuitry for obtaining 1315 and circuitry for sending 1320. Processing with circuitry 1315 and 1320 may enable and cause the communications device 1300 to perform the method 1100 described with respect to FIG. 11, or any aspect related to it. For instance, in some aspects, circuitry for obtaining 1315 includes circuitry for obtaining a first configuration that schedules transmission of a PT-RS on one or more first resource elements of a first symbol. In some aspects, circuitry for obtaining 1315 includes circuitry for obtaining a second configuration comprising a muting pattern for the first symbol, the muting pattern indicating one or more second resource elements to be muted on the first symbol. In some aspects, circuitry for sending 1320 includes circuitry for sending, according to a power boosting scheme associated with the PT-RS and the muting pattern, an uplink message on the first symbol in accordance with the PT-RS and the muting pattern.

More generally, means for communicating, transmitting, sending or outputting for transmission may include the one or more transceivers 324, one or more antenna 322 and/or processing system 316 of the UE 304 illustrated in FIG. 3, transceiver 1345 and/or antenna 1350 of the communications device 1300 in FIG. 13, and/or one or more processors 1310 of the communications device 1300 in FIG. 13. Means for communicating, receiving or obtaining may include the one or more transceivers 324, one or more antennas 322, and/or processing system 316 of the UE 304 illustrated in FIG. 3, transceiver 1345 and/or antenna 1350 of the communications device 1300 in FIG. 13, and/or one or more processors 1310 of the communications device 1300 in FIG. 13.

FIG. 14 depicts aspects of an example communications device configured for wireless communications. In some aspects, communications device 1400 is a network entity, such as BS 102 of FIG. 1, first network entity 300 or second network entity 302 of FIG. 3, or a disaggregated base station as discussed with respect to FIG. 2.

The communications device 1400 includes a processing system 1405 coupled to a transceiver 1445 (e.g., a transmitter and/or a receiver) and/or a network interface 1455. The transceiver 1445 is configured to transmit and receive signals for the communications device 1400 via an antenna 1450, such as the various signals as described herein. The network interface 1455 is configured to obtain and send signals for the communications device 1400 via communications link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410 and a computer-readable medium/memory 1425. In various aspects, one or more processors 1410 may be representative of the one or more processors 308, as described with respect to FIG. 3. The one or more processors 1410 are coupled to the computer-readable medium/memory 1425 via a bus 1440. In certain aspects, the computer-readable medium/memory 1425 is configured to store instructions (e.g., computer-executable code), including code 1430 and 1435, that when executed by the one or more processors 1410, cause the one or more processors 1410 to perform the method 1200 described with respect to FIG. 12, or any aspect related to it, including any operations described in relation to FIG. 12. The computer-readable medium/memory 1425 is a non-transitory computer-readable medium/memory. Note that reference to a processor of communications device 1400 performing a function may include one or more processors of communications device 1400 performing that function, such as in a distributed fashion.

In the depicted example, the computer-readable medium/memory 1425 stores code (e.g., executable instructions), including code for sending 1430 and code for obtaining 1435. Processing of the code 1430 and 1435 may enable and cause the communications device 1400 to perform the method 1200 described with respect to FIG. 12, or any aspect related to it. For instance, in some aspects, code for sending 1430 includes code for sending a first configuration that schedules transmission of a PT-RS on one or more first resource elements of a first symbol. In some aspects, code for sending 1430 includes code for sending a second configuration comprising a muting pattern for the first symbol, the muting pattern indicating one or more second resource elements to be muted on the first symbol. In some aspects, code for obtaining 1435 includes code for obtaining, according to a power boosting scheme associated with transmission of the PT-RS and the muting pattern, an uplink message on the first symbol in accordance with the PT-RS and the muting pattern.

The one or more processors 1410 include circuitry configured to implement (e.g., execute) the code stored in the computer-readable medium/memory 1425, including circuitry for sending 1415 and circuitry for obtaining 1420. Processing with circuitry 1415 and 1420 may enable and cause the communications device 1400 to perform the method 1200 described with respect to FIG. 12, or any aspect related to it. For instance, in some aspects, circuitry for sending 1415 includes circuitry for sending a first configuration that schedules transmission of a PT-RS on one or more first resource elements of a first symbol. In some aspects, circuitry for sending 1415 includes circuitry for sending a second configuration comprising a muting pattern for the first symbol, the muting pattern indicating one or more second resource elements to be muted on the first symbol. In some aspects, circuitry for obtaining 1420 includes circuitry for obtaining, according to a power boosting scheme associated with transmission of the PT-RS and the muting pattern, an uplink message on the first symbol in accordance with the PT-RS and the muting pattern.

Various components of the communications device 1400 may provide means for performing the method 1200 described with respect to FIG. 12, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1445, antenna 1450, and/or network interface 1455 of the communications device 1400 in FIG. 14, and/or one or more processors 1410 of the communications device 1400 in FIG. 14. Means for communicating, receiving or obtaining may include the one or more transceivers 312, one or more antennas 314, and/or processing system 306 of the first network entity 300 or the second network entity 302 illustrated in FIG. 3, transceiver 1445, antenna 1450, and/or network interface 1455 of the communications device 1400 in FIG. 14, and/or one or more processors 1410 of the communications device 1400 in FIG. 14.

### Example Clauses

Implementation examples are described in the following numbered clauses:

Clause 1: A method for wireless communications by a UE comprising: obtaining a first configuration that schedules transmission of a PT-RS on one or more first resource elements of a first symbol; obtaining a second configuration comprising a muting pattern for the first symbol, the muting pattern indicating one or more second resource elements to be muted on the first symbol; and sending, according to a power boosting scheme associated with the PT-RS and the muting pattern, an uplink message on the first symbol in accordance with the PT-RS and the muting pattern.

Clause 2: The method of Clause 1, wherein: the power boosting scheme indicates a same power boosting value for the one or more first resource elements and for one or more third resource elements of the first symbol, and the one or more third resource elements comprise data resource elements that are not muted according to the muting pattern.

Clause 3: The method of Clause 2, wherein the same power boosting value comprises three decibels.

Clause 4: The method of Clause 2, wherein an EPRE for the PT-RS has a first value on the first symbol and a second value on a second symbol, wherein the second value is different than the first value.

Clause 5: The method of any one of Clauses 1-4, wherein: the power boosting scheme indicates a first power boosting value for one or more third resource elements of the first symbol and a second power boosting value for the one or more first resource elements, and the one or more third resource elements comprise data resource elements that are not muted according to the muting pattern.

Clause 6: The method of Clause 5, wherein the first power boosting value comprises three decibels.

Clause 7: The method of Clause 5, wherein: the second power boosting value is based on a PT-RS power boost indicated in the first configuration, and the PT-RS power boost is based on a transmission power for the one or more third resource elements before the first power boosting value.

Clause 8: The method of Clause 5, wherein: an EPRE for the PT-RS is the same across a plurality of symbols, and the plurality of symbols comprises the first symbol.

Clause 9: The method of any one of Clauses 1-8, wherein: the power boosting scheme indicates a power boosting factor for one or more third resource elements of the first symbol, and the one or more third resource elements comprise data resource elements that are not muted according to the muting pattern.

Clause 10: The method of Clause 9, wherein the power boosting factor is based on a PT-RS density indicated in the first configuration.

Clause 11: The method of Clause 9, wherein the one or more first resource elements are not power boosted.

Clause 12: The method of any one of Clauses 1-11, wherein: the power boosting scheme indicates a power boosting value for one or more third resource elements of the first symbol and a power boosting factor for the one or more first resource elements, and the one or more third resource elements comprise data resource elements that are not muted according to the muting pattern.

Clause 13: The method of Clause 12, wherein the power boosting value comprises three decibels.

Clause 14: The method of Clause 12, wherein: the power boosting factor is associated with a same per-symbol power across a plurality of symbols, and the plurality of symbols comprise the first symbol.

Clause 15: The method of any one of Clauses 1-14, wherein the one or more first resource elements and the one or more second resource elements do not overlap with one another in the first symbol.

Clause 16: The method of any one of Clauses 1-15, wherein the uplink message comprises a CP-OFDM waveform.

Clause 17: A method for wireless communications by a network entity comprising: sending a first configuration that schedules transmission of a PT-RS on one or more first resource elements of a first symbol; sending a second configuration comprising a muting pattern for the first symbol, the muting pattern indicating one or more second resource elements to be muted on the first symbol; and obtaining, according to a power boosting scheme associated with transmission of the PT-RS and the muting pattern, an uplink message on the first symbol in accordance with the PT-RS and the muting pattern.

Clause 18: The method of Clause 17, wherein: the power boosting scheme indicates a same power boosting value for the one or more first resource elements and for one or more third resource elements of the first symbol, and the one or more third resource elements comprise data resource elements that are not muted according to the muting pattern.

Clause 19: The method of Clause 18, wherein the same power boosting value comprises three decibels.

Clause 20: The method of Clause 18, wherein an EPRE for the PT-RS has a first value on the first symbol and a second value on a second symbol, wherein the second value is different than the first value.

Clause 21: The method of any one of Clauses 17-20, wherein: the power boosting scheme indicates a first power boosting value for one or more third resource elements of the first symbol and a second power boosting value for the one or more first resource elements, and the one or more third resource elements comprise data resource elements that are not muted according to the muting pattern.

Clause 22: The method of Clause 21, wherein the first power boosting value comprises three decibels.

Clause 23: The method of Clause 21, wherein: the second power boosting value is based on a PT-RS power boost indicated in the first configuration, and the PT-RS power boost is based on a transmission power for the one or more third resource elements before the first power boosting value.

Clause 24: The method of Clause 21, wherein: an EPRE for the PT-RS is the same across a plurality of symbols, and the plurality of symbols comprises the first symbol.

Clause 25: The method of any one of Clauses 17-24, wherein: the power boosting scheme indicates a power boosting factor for one or more third resource elements of the first symbol, and the one or more third resource elements comprise data resource elements that are not muted according to the muting pattern.

Clause 26: The method of Clause 25, wherein the power boosting factor is based on a PT-RS density indicated in the first configuration.

Clause 27: The method of Clause 25, wherein the one or more first resource elements are not power boosted.

Clause 28: The method of any one of Clauses 17-27, wherein: the power boosting scheme indicates a power boosting value for one or more third resource elements of the first symbol and a power boosting factor for the one or more first resource elements, and the one or more third resource elements comprise data resource elements that are not muted according to the muting pattern.

Clause 29: The method of Clause 28, wherein the power boosting value comprises three decibels.

Clause 30: The method of Clause 28, wherein: the power boosting factor is associated with a same per-symbol power across a plurality of symbols, and the plurality of symbols comprise the first symbol.

Clause 31: The method of any one of Clauses 17-30, wherein the one or more first resource elements and the one or more second resource elements do not overlap with one another in the first symbol.

Clause 32: The method of any one of Clauses 17-31, wherein the uplink message comprises a CP-OFDM waveform.

Clause 33: One or more apparatuses, comprising: one or more memories comprising executable instructions; and one or more processors configured to execute the executable instructions and cause the one or more apparatuses to perform a method in accordance with any one of Clauses 1-32.

Clause 34: One or more apparatuses configured for wireless communications, comprising: one or more memories; and one or more processors, coupled to the one or more memories, configured to cause the one or more apparatuses to perform a method in accordance with any one of Clauses 1-32.

Clause 35: One or more apparatuses configured for wireless communications, comprising: one or more memories; and one or more processors, coupled to the one or more memories, configured to perform a method in accordance with any one of Clauses 1-32.

Clause 36: One or more apparatuses, comprising means for performing a method in accordance with any one of Clauses 1-32.

Clause 37: One or more non-transitory computer-readable media comprising executable instructions that, when executed by one or more processors of one or more apparatuses, cause the one or more apparatuses to perform a method in accordance with any one of Clauses 1-32.

Clause 38: One or more computer program products embodied on one or more computer-readable storage media comprising code for performing a method in accordance with any one of Clauses 1-32.

Clause 39: One or more apparatuses configured for wireless communications, comprising: a processing system that includes one or more processors and one or more memories coupled with the one or more processors, the processing system configured to cause the one or more apparatuses to perform a method in accordance with any one of Clauses 1-32.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
obtain a first configuration that schedules transmission of a phase tracking reference signal (PT-RS) on one or more first resource elements of a first symbol;
obtain a second configuration comprising a muting pattern for the first symbol, the muting pattern indicating one or more second resource elements to be muted on the first symbol; and
send, according to a power boosting scheme associated with the PT-RS and the muting pattern, an uplink message on the first symbol in accordance with the PT-RS and the muting pattern.

2. The apparatus of claim 1, wherein:
the power boosting scheme indicates a same power boosting value for the one or more first resource elements and for one or more third resource elements of the first symbol, and
the one or more third resource elements comprise data resource elements that are not muted according to the muting pattern.

3. The apparatus of claim 2, wherein the same power boosting value comprises three decibels.

4. The apparatus of claim 2, wherein an energy per resource element (EPRE) for the PT-RS has a first value on the first symbol and a second value on a second symbol, wherein the second value is different than the first value.

5. The apparatus of claim 1, wherein:
the power boosting scheme indicates a first power boosting value for one or more third resource elements of the first symbol and a second power boosting value for the one or more first resource elements, and
the one or more third resource elements comprise data resource elements that are not muted according to the muting pattern.

6. The apparatus of claim 5, wherein the first power boosting value comprises three decibels.

7. The apparatus of claim 5, wherein:
the second power boosting value is based on a PT-RS power boost indicated in the first configuration, and
the PT-RS power boost is based on a transmission power for the one or more third resource elements before the first power boosting value.

8. The apparatus of claim 5, wherein:
an energy per resource element (EPRE) for the PT-RS is the same across a plurality of symbols, and
the plurality of symbols comprises the first symbol.

9. The apparatus of claim 1, wherein:
the power boosting scheme indicates a power boosting factor for one or more third resource elements of the first symbol, and
the one or more third resource elements comprise data resource elements that are not muted according to the muting pattern.

10. The apparatus of claim 9, wherein the power boosting factor is based on a PT-RS density indicated in the first configuration.

11. The apparatus of claim 9, wherein the one or more first resource elements are not power boosted.

12. The apparatus of claim 1, wherein:
the power boosting scheme indicates a power boosting value for one or more third resource elements of the first symbol and a power boosting factor for the one or more first resource elements, and
the one or more third resource elements comprise data resource elements that are not muted according to the muting pattern.

13. The apparatus of claim 12, wherein the power boosting value comprises three decibels.

14. The apparatus of claim 12, wherein:
the power boosting factor is associated with a same per-symbol power across a plurality of symbols, and
the plurality of symbols comprise the first symbol.

15. The apparatus of claim 1, wherein the one or more first resource elements and the one or more second resource elements do not overlap with one another in the first symbol.

16. The apparatus of claim 1, wherein the uplink message comprises a cyclic prefix-orthogonal frequency division multiplexing (CP-OFDM) waveform.

17. An apparatus for wireless communications, comprising a processing system that includes one or more processors and one or more memories coupled with the one or more processors, the processing system configured to cause a network entity to:
send a first configuration that schedules transmission of a phase tracking reference signal (PT-RS) on one or more first resource elements of a first symbol;
send a second configuration comprising a muting pattern for the first symbol, the muting pattern indicating one or more second resource elements to be muted on the first symbol; and
obtain, according to a power boosting scheme associated with transmission of the PT-RS and the muting pattern, an uplink message on the first symbol in accordance with the PT-RS and the muting pattern.

18. The apparatus of claim 17, wherein:
the power boosting scheme indicates a same power boosting value for the one or more first resource elements and for one or more third resource elements of the first symbol, and
the one or more third resource elements comprise data resource elements that are not muted according to the muting pattern.

19. The apparatus of claim 18, wherein the same power boosting value comprises three decibels.

20. A method for wireless communications by a user equipment (UE) comprising:
obtaining a first configuration that schedules transmission of a phase tracking reference signal (PT-RS) on one or more first resource elements of a first symbol;
obtaining a second configuration comprising a muting pattern for the first symbol, the muting pattern indicating one or more second resource elements to be muted on the first symbol; and
sending, according to a power boosting scheme associated with the PT-RS and the muting pattern, an uplink message on the first symbol in accordance with the PT-RS and the muting pattern.
